(19) United States
(12) Patent Application Publication
(10) Pub. No.: US 2013/0321900 A1
(43) Pub. Date: Dec. 5, 2013

(54) OPTICAL BROADBAND FILTER AND DEVICE COMPRISING THE SAME

(71) Applicants: Tuomas Vallius, Tammelankatu (FI); Janne Konttinen, Kullervonkatu (FI); Pietari Tuormisto, Rintamaenkatu (FI)

(72) Inventors: Tuomas Vallius, Tammelankatu (FI); Janne Konttinen, Kullervonkatu (FI); Pietari Tuormisto, Rintamaenkatu (FI)

(73) Assignee: EpiCrystals Oy, Tampere (FI)

(21) Appl. No.: 13/991,126

(22) PCT Filed: Dec. 1, 2011
(86) PCT No.: PCT/FI2011/051071

§ 371 Date: Aug. 22, 2013

Related U.S. Application Data
(60) Provisional application No. 61/418,478, filed on Dec. 1, 2010.
(60) Provisional application No. 61/491,007, filed on May 27, 2011.

(51) Int. Cl. G02B 5/18

(52) U.S. Cl. CPC G02B 5/1861
USPC 359/328; 359/572; 359/326

(57) ABSTRACT

A device including a combination of a waveguide and a grating arranged to provide a spectral reflectance. The grating has a plurality of diffractive features in a first region and in a second region such that in the first region, a local average of a length of a period of the diffractive features substantially increases with increasing distance from an origin, and in the second region, the local average of the length of the period of the diffractive features substantially decreases with increasing distance from an origin. The origin is located at an end of the device.

### REFERENCES TO PREVIOUS APPLICATIONS

The present application makes a reference to U.S. provisional application 61/418,478, herein incorporated by reference. The present application makes a reference to U.S. patent application Ser. No. 12/523,763, herein incorporated by reference.

### FIELD OF THE INVENTION

The present invention relates to filtering light by a using a diffractive grating attached to a waveguide. The present invention also relates to a device comprising a diffractive grating.

### BACKGROUND

Referring to FIG. 1, an optical filter 80 may comprise a waveguide 92 and a grating G1. The grating G1 may comprise a plurality of periodically arranged diffractive features 83, e.g. diffractive ridges implemented on a layer 95. An input beam B1 propagating in the waveguide 92 may interact with the periodic perturbation caused by the grating G1 such that a portion of light may be reflected.

A part of an input beam B1 may be reflected backwards providing a reflected beam R1. A residual part of the input beam B1 may be transmitted through the waveguide 92 providing a transmitted beam BT.

The intensity of reflected light R1 may depend on the wavelength λ, i.e. the filter 80 has a certain spectral reflectance.

The coupling between the input beam B1 and the reflected beam R1 at different locations may be governed by using the coupling coefficient function κ_{AB}(z). z defines a distance from an origin ORIG in the direction SZ. The direction SX is perpendicular to the direction SZ. Λ_{B} denotes the length of the grating period.

Referring to FIG. 2, an ideal spectral reflectance function for many applications would be a substantially rectangular function. λ₀ denotes a central wavelength, and Δλ_{FWHM} denotes the full width at half maximum. An (ideal) spectral reflectance I_{R}(λ)/I₁(λ) may be substantially equal to a maximum value MAXV when λ₀−Δλ_{FWHM}/2≦λ≦λ₀+Δλ_{FWHM}/2. The spectral reflectance may be substantially equal to zero when λ<λ₀−Δλ_{FWHM}/2 or when λ>λ₀+Δλ_{FWHM}/2.

Δλ_{80%} denotes the spectral width at a height, which is 80% of the maximum value MAXV. In case of the rectangular function, the value Δλ_{80%} is substantially equal to the value Δλ_{FWHM}.

A known approach to implement an optical filter is to use a constant grating period, i.e. so that the value of Λ_{B}(z) does not depend on the distance z. FIG. 3 shows a typical spectral reflectance provided by using a constant grating period Λ_{B}(z). In that case, the wavelength dependence of the reflectance may obey the equation:

$$\frac{{I}_{R} ( λ )}{{I}_{1} ( λ )} = K \cdot {L}_{B} \cdot sin {c}^{2} [ ( \frac{4 π {n}_{eff}}{λ} - \frac{2 π}{{Λ}_{B}} ) {L}_{B} ] \qquad ( 1 )$$

where I_{R}(λ) denotes the spectral intensity of the reflected beam R1, I₁(λ) denotes the spectral intensity of the input beam B1, L_{B} denotes the length of the grating, Λ_{B} denotes the period of the grating, λ denotes the optical wavelength, n_{eff} denotes an effective refractive index of the waveguiding layer 92 perturbed by the grating, and K denotes a proportionality constant. In case of eq. (1), grating period Λ_{B}(z) is spatially constant, and the maximum value of the reflectance is assumed to be substantially smaller than 100%.

It may be noticed that the spectral reflectance shown in FIG. 3 substantially deviates from the ideal rectangular curve of FIG. 2.

In case of the constant grating period, the wavelength band where the reflectance is close to the maximum value MAXV is narrow, regardless of the period length Λ_{B} and/or the grating length L_{B}. This may be a problem in several applications. Even small deviations from the central wavelength λ₀ may substantially reduce the intensity I_{R}(λ) of reflected light R1.

In the curve of FIG. 3, the spectral width Δλ_{80%} is only 53% of the spectral width Δλ_{FWHM}.

A known approach to increase the width of the spectral reflectance function is to apply chirping to the grating period. Chirping means that the length Λ_{B} of the grating period increases with increasing distance z from an origin ORIG, as shown in FIG. 4a. Unfortunately, this approach typically distorts the spectral reflectance as shown in FIG. 4b. In this comparative example, the shape of the curve is strongly deformed at the central area of the curve.

An attempt to use a chirped grating to stabilize the output wavelength of a semiconductor laser may lead to unstable lasing properties. In particular, small variations in the operating temperature of the laser and/or in the operating temperature of the grating may cause random variations in the output wavelength.

It is known that the grating period may be varied according to so-called Barker coding. However, also the use of the Barker coding may typically lead to strong perturbations of the order of ±30% in the shape of the spectral reflectance curve.

It is known that the shape of the spectral reflectance curve may be modified by using apodisation, i.e. by varying the duty ratio of the grating. Unfortunately, this would increase the length of the grating and would require manufacturing accuracy, which may be beyond the capabilities of current production apparatus.

### SUMMARY

An object of the present invention is to provide an optical filter having a wide spectral reflectance band. An object of the present invention is to provide a method for manufacturing such an optical filter. An object of the present invention is to provide a light source whose output is stabilized by using an optical filter.

According to a first aspect of the present invention, there is provided a device according to claim 1.

According to a second aspect of the present invention, there is provided a method for filtering light according to claim 16.

According to a third aspect of the present invention, there is provided a method for producing a device according to claim 19.

According to the invention, a device may comprise a waveguide and a perturbing grating, wherein the grating has a first region and a second region such that the (averaged) lengths of the grating periods increase with increasing distance from an origin in the first region, and the (averaged) lengths of the grating periods decrease with increasing distance in the second region.

The lengths Λ_{B} of the grating period in different locations z may be defined by a grating period function Λ_{B}(z). The grating period function Λ_{B}(z) may substantially correspond to the phase of a Fourier transform of the square root of a desired spectral reflectance function I_{R}(λ). In particular, the ratio of the width Δλ_{80%} to the width Δλ_{FWHM} of said (desired) spectral reflectance function may be greater than or equal to 0.6.

Thus, the lengths of the grating periods may be different in different locations such that the spectral reflectance of the grating has a desired form and width. In particular, lengths of the grating periods at different locations may be selected such that the spectral reflectance band provided by the grating has a substantially wide and substantially flat top.

In an embodiment, a light source may comprise the grating, and a laser light emitter such that the grating is arranged to provide optical feedback to the laser emitter. In this case, the wide reflectance band may be used to reduce undesirable speckle of light generated by the light source.

In an embodiment, the grating may be arranged to stabilize optical wavelength of light source, which comprises a nonlinear crystal. The nonlinear crystal be arranged to provide second light from first light by sum frequency generation (SFG) and/or by second harmonic generation (SHG). Consequently, small deviations in the wavelength of the first light do not cause excessive fluctuations in the optical power provided by the light source.

Thanks to the grating, the efficiency and/or output power of the light source may be increased. Thanks to the grating, temporal stability of the output power of the light source may be improved. In an embodiment, the use of the grating may relieve or eliminate a need to accurately stabilize the operating temperature of the nonlinear crystal.

### BRIEF DESCRIPTION OF THE DRAWINGS

In the following examples, the embodiments of the invention will be described in more detail with reference to the appended drawings in which

FIG. 1 shows, in a side view, an optical filter comprising a waveguide and a grating arranged to spatially modulate the refractive index of the waveguide,

FIG. 2 shows a rectangular spectral reflectance,

FIG. 3 shows a typical spectral reflectance provided by an optical filter, which has spatially constant grating period length,

FIG. 4a shows, by way of example, spatial variation of grating period length of a chirped grating,

FIG. 4b shows the spectral reflectance of an optical filter, which has the chirped grating of FIG. 4a,

FIG. 5 shows, by way of example, a spectral reflectance having a substantially flat top,

FIG. 6a shows, by way of example, spatial variation of grating period length,

FIG. 6b shows, by way of example, a constant duty cycle of a grating,

FIG. 6c shows, by way of example, a spatially varying duty cycle which is a function of the grating period function,

FIG. 7a shows, by way of example, steps of an Iterative Fourier Transformation Algorithm (IFTA),

FIG. 7b shows, by way of example, steps of the Iterative Fourier Transformation Algorithm together with amplitude curves and phase curves,

FIG. 8a shows, by way of example, a spectral reflectance having a substantially flat top,

FIG. 8b shows, by way of example, the phase of a coupling coefficient function corresponding to the spectral reflectance function of FIG. 8a,

FIG. 8c shows, by way of example, a spatial variation of period length corresponding to the spectral reflectance function of FIG. 8a,

FIG. 8d shows, by way of example, implementing desired averaged period lengths by using quantized period lengths,

FIG. 9 shows, by way of example, implementing desired averaged period lengths by using quantized period lengths,

FIG. 10 shows, by way of example, spectral reflectance curves provided by three different gratings,

FIG. 11a shows, by way of example, spatial variation of intensity of a reflected wave at four different spectral positions,

FIG. 11b shows, by way of example, spatial variation of intensity of a forward-propagating wave at four different spectral positions,

FIG. 12 shows, by way of example, a second grating period function obtained by shifting a first grating period function,

FIG. 13a shows, by way of example, a spectral reflectance having several peaks,

FIG. 13b shows, by way of example, a spectral reflectance having several peaks,

FIG. 14a shows, in a side view, an optical filter comprising a waveguide and a grating, wherein the grating is shorter than the waveguide,

FIG. 14b shows, in a side view, an optical filter having a substrate and a protective layer,

FIG. 14c shows, in a side view, an optical filter, wherein a grating is implemented between a waveguide and a substrate,

FIG. 15a shows an optical filter arranged to provide optical feedback to a light-emitting unit,

FIG. 15b shows, in a side view, a light source comprising an optical filter arranged to provide optical feedback,

FIG. 16a shows providing light by sum frequency generation,

FIG. 16b shows a light source comprising a nonlinear crystal and a an optical filter arranged to provide optical feedback,

FIG. 16c shows, in a three-dimensional view, a light source comprising a nonlinear crystal and a an optical filter arranged to provide optical feedback,

FIG. 16d shows, in a side view, a light source having a folded configuration,

FIG. 17a shows, in a side view, optical coupling between a nonlinear crystal and an optical filter,

FIG. 17b shows, in a side view, a nonlinear crystal comprising a grating,

FIG. 18 shows, by way of example, spectral conversion efficiency function of a nonlinear crystal,

FIG. 19a shows, by way of example, spatial variation of poling period length of a nonlinear crystal,

FIG. 19b shows, by way of example, spatial variation of poling period length of a nonlinear crystal, and spatial variation of a grating period length of a grating implemented on the waveguide of the nonlinear crystal,

FIG. 20 shows a device comprising a grating, and

FIG. 21 shows a system comprising wavelength division multiplexer couplers.

All drawings are schematic.

### DETAILED DESCRIPTION

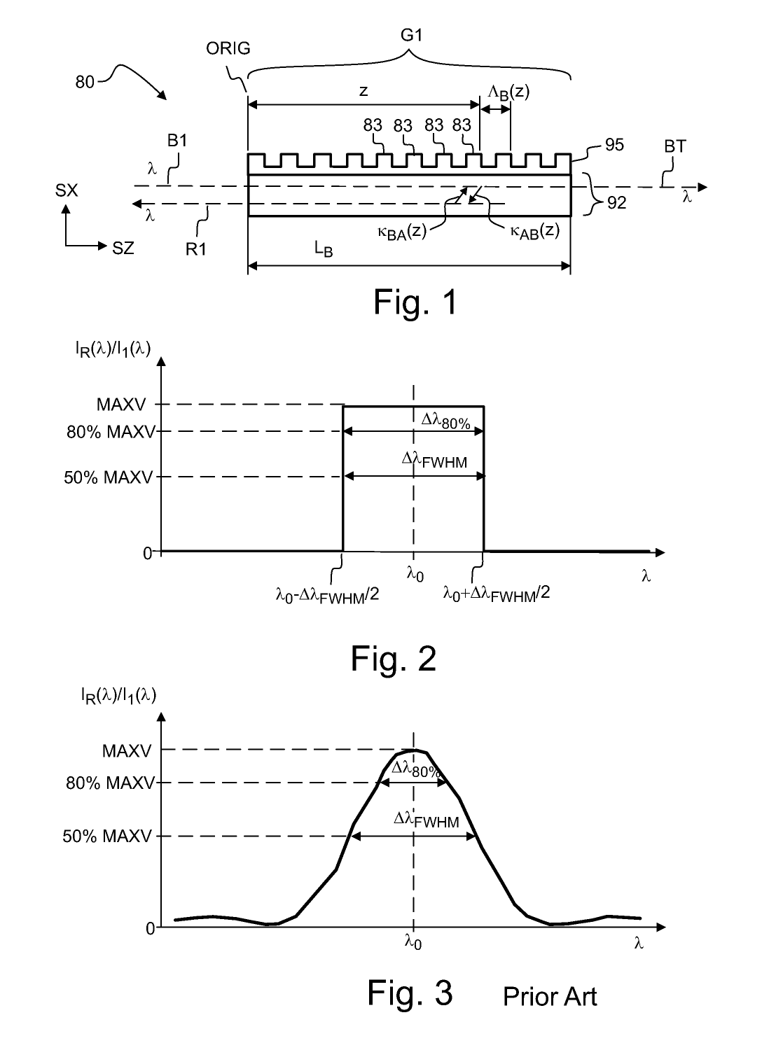

Referring to FIG. 1, an optical component 80 may comprise a waveguide 92 arranged to guide an input beam B1. The input beam B1 may be confined to the waveguide 92 by total internal reflection (TIR). The optical component 80 may be e.g. an optical filter.

The optical component 80 may comprise a grating G1, which is arranged to periodically perturb the waveguide 92. The perturbation may also be called as spatial modulation of the refractive index of the waveguide 92. The grating G1 comprises a plurality of periodically arranged diffractive features 83, e.g. diffractive ridges. FIG. 1 shows diffractive ridges implemented on an additional grating layer 95, but diffractive features 83 may also be implemented e.g. directly on the material of the waveguide 92.

The total length of the perturbed area of the grating G1 in the direction SZ may be substantially equal to L_{B}. The perturbed area refers to the area covered by the diffractive features 83.

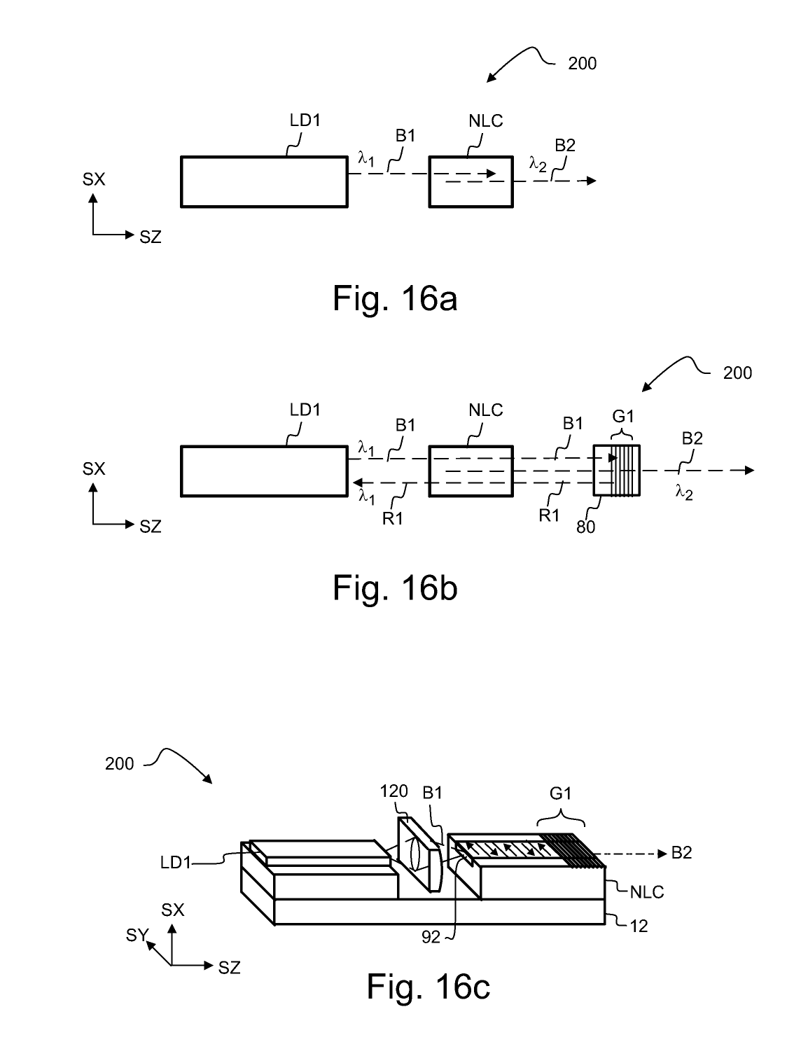

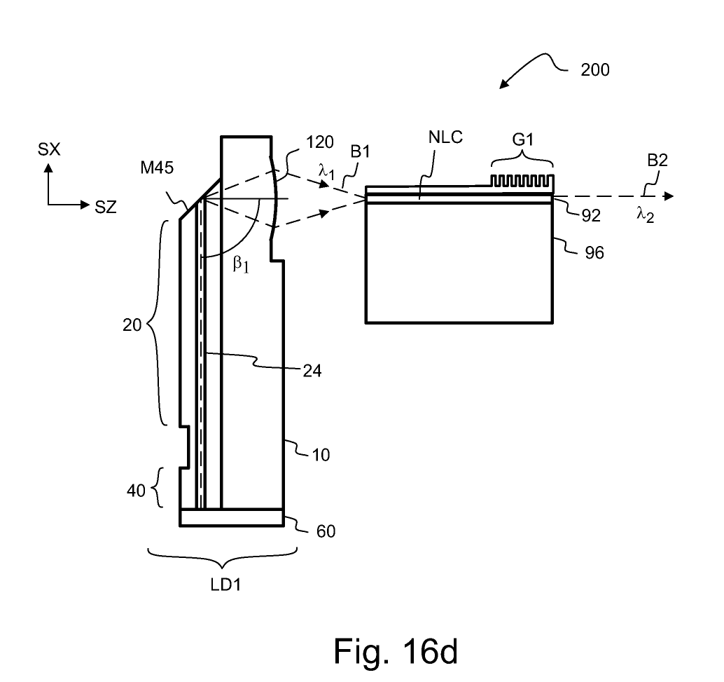

The diffractive features 83 may also be called as perturbing features or perturbing elements. The diffractive features 83 may be positioned substantially periodically such that they have a period length Λ_{B}. The period length Λ_{B} may depend on the position z, i.e. the period length may be expressed as a function Λ_{B}(z). The period length Λ_{B} may be e.g. smaller than 1 μm. The period length Λ_{B} may be determined in the direction of propagation of the light B1 (i.e. in the direction SZ). SX, SY and SZ denote orthogonal directions (the direction SY is shown in FIG. 16c).

An input beam B1 propagating in the waveguide 92 may interact with the periodic perturbation caused by the grating G1 such that a portion of light may be reflected.

A part of an input beam B1 may be reflected backwards providing a reflected beam R1. A residual part of the input beam B1 may be transmitted through the waveguide 92 providing a transmitted beam BT. When the input light beam B1 has a component at a wavelength λ, also the reflected beam R1 and the transmitted beam BT may have a component at the same wavelength λ.

Optical coupling between a first beam and a second beam may be governed by using a coupling coefficient, as discussed e.g. in a publication H. Nishihara, M. Haruna, and T. Suhara, “Optical Integrated Circuits”, pages 55-63, (1986). The coupling between the input beam B1 and the reflected beam R1 at different locations may be governed by using the coupling coefficient function κ_{AB}(z). The coupling coefficient function κ_{AB}(z) refers to a coupling coefficient, whose value depends on the location. z defines a distance from an origin ORIG in the direction SZ. A grating period function Λ_{B}(z) defines the grating period length at different positions z.

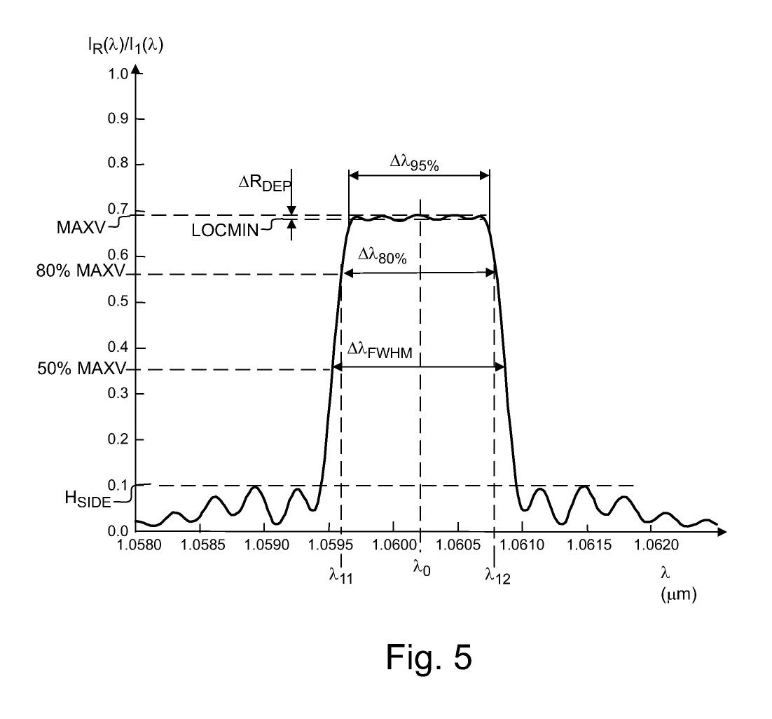

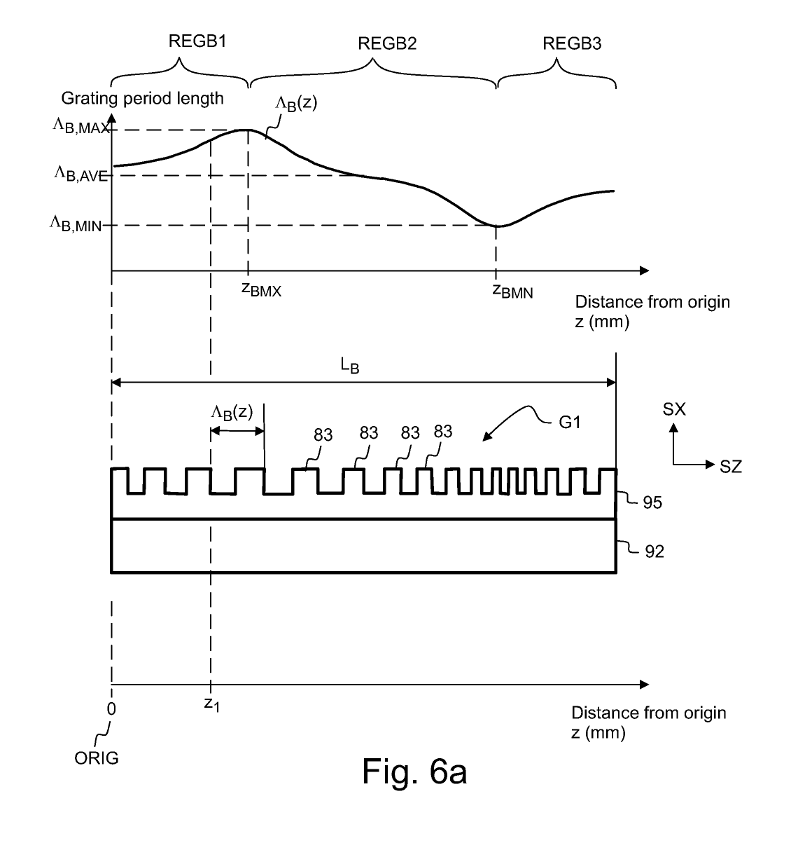

The intensity of reflected light R1 may depend on the wavelength λ, i.e. the filter 80 has a certain spectral reflectance defined by spectral reflectance function I_{R}(λ)/I₁(λ). Within certain constraints, the form of the spectral reflectance function I_{R}(λ)/I₁(λ) may be modified by selecting a suitable grating period function Λ_{B}(z). FIG. 5 shows an example of a spectral reflectance I_{R}(λ)/I₁(λ), which may be provided by a grating G1 whose grating period function Λ_{B}(z) has a first region where the grating period length increases with increasing distance z from the origin ORIG, and a second region where the grating period length decreases with increasing distance z from the origin ORIG

The spectral reflectance band of FIG. 5 would be nearly optimal for various applications. The spectral reflectance curve of FIG. 5 has a substantially rectangular top. In other words, the central portion of the spectral reflectance curve of FIG. 5 substantially resembles the rectangular function of FIG. 2.

The spectral reflectance curve may have several peaks located within the width Δλ_{80%}. In that case, the spectral reflectance curve may have one or more local depressions (i.e. local minima) between said peaks. LOCMIN denotes the minimum value of the spectral reflectance curve between two peaks located within the spectral locations λ₁₁, λ₁₂. ΔR_{DEP} denotes a difference between the maximum value MAXV and the local minimum value LOCMIN. ΔR_{DEP} may also be called as the depth of depression.

In case of FIG. 5, the fluctuations ΔR_{DEP} in the vicinity of the central wavelength λ₀ are small (approximately 2%) when compared with the maximum value MAXV. The ratio of the width Δλ_{95%} to the width Δλ_{FWHM} is approximately equal to 0.83. The ratio of the width Δλ_{80%} to the width Δλ_{FWHM} is approximately equal to 0.89. H_{SIDE} denotes the maximum height of the sidebands. In this case the height H_{SIDE} is approximately equal to 14% of the maximum value MAXV.

Δλ_{FWHM} denotes the spectral width at a height, which is half (50%) of the maximum value MAXV. FWHM denotes full width at half maximum. Δλ_{80%} denotes the spectral width at a height, which is 80% of the maximum value MAXV. Δλ_{95%} denotes the spectral width at a height, which is 95% of the maximum value MAXV. The spectral reflectance may reach 80% of the maximum value MAXV at the spectral locations λ₁₁, λ₁₂. The width Δλ_{80%} is equal to the difference λ₁₂−λ₁₁.

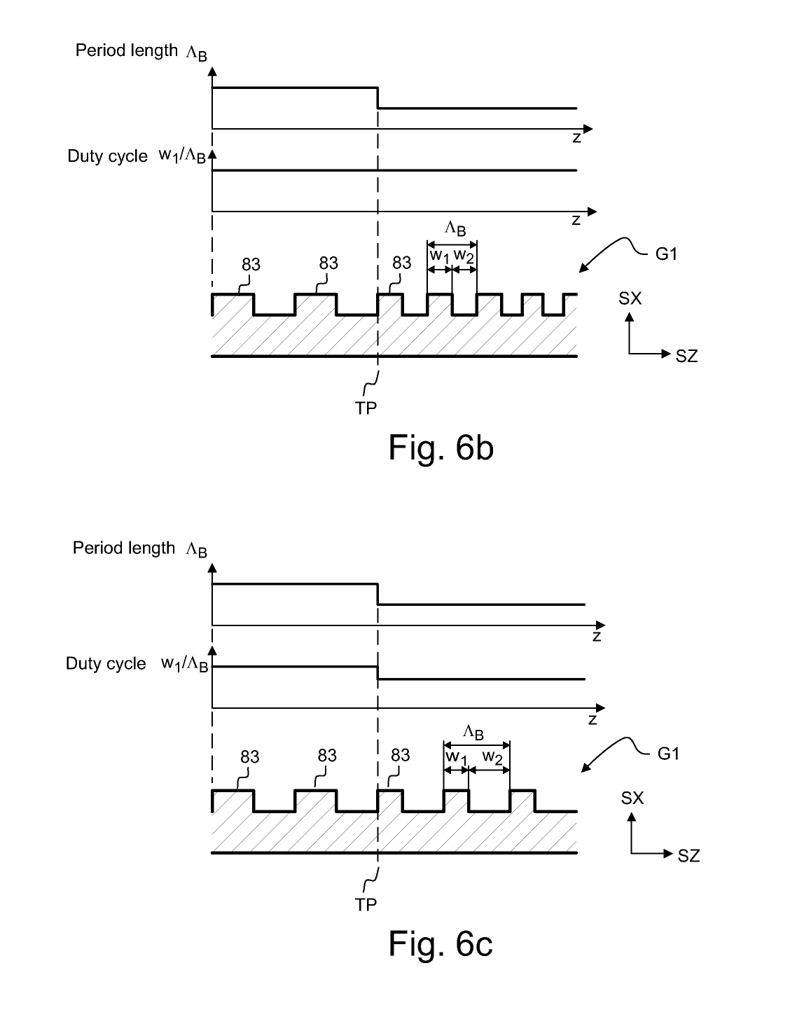

Referring to FIG. 6a, the length of the grating periods Λ_{B} of the grating G1 may be varied as a function of location z in order to provide a spectral reflectance band, which has a wide and flat top. In other words, the length of a period of the grating G1 may depend on the location z of said period.

The grating period length Λ_{B} may be expressed as a function Λ_{B}(z) of the distance z. Each position z is associated with a certain value of the grating period function” Λ_{B}(z). For example, at the distance z=z₁, the length of the period length may be equal to Λ_{B}(z₁).

The “grating period function” Λ_{B}(z) or a “value of the grating period function” may also be simply called as the “grating period”.

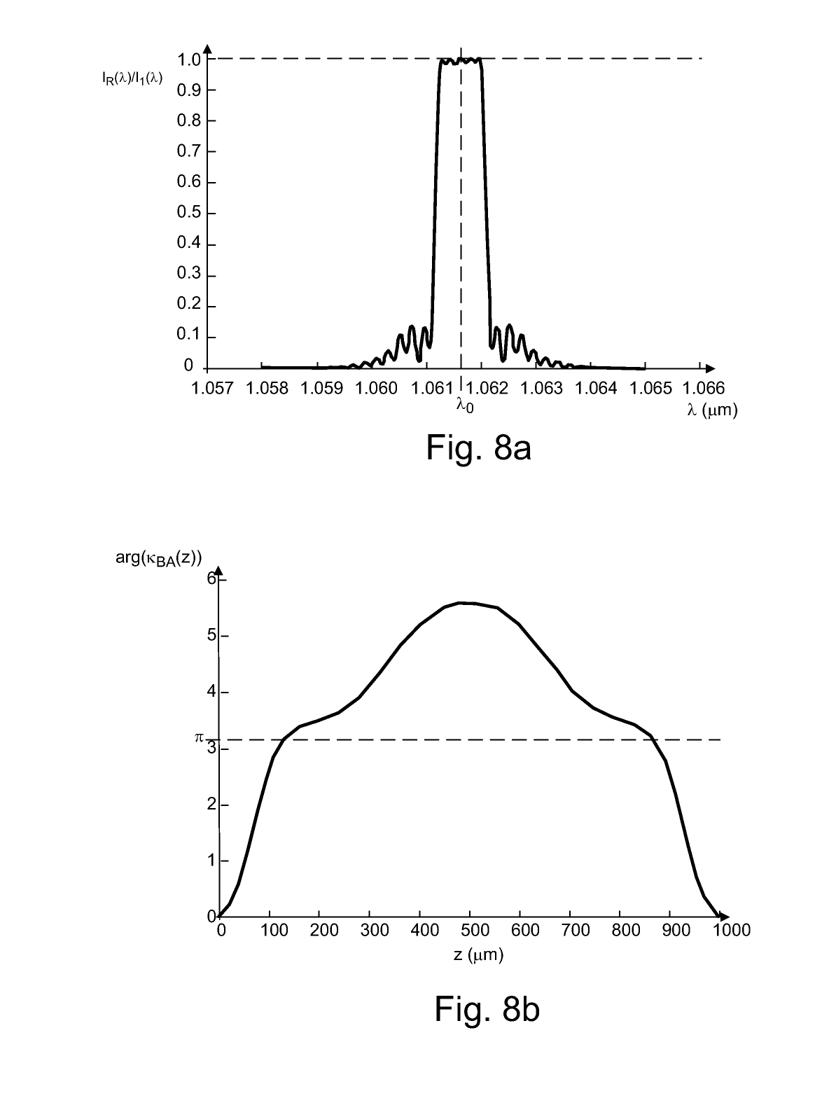

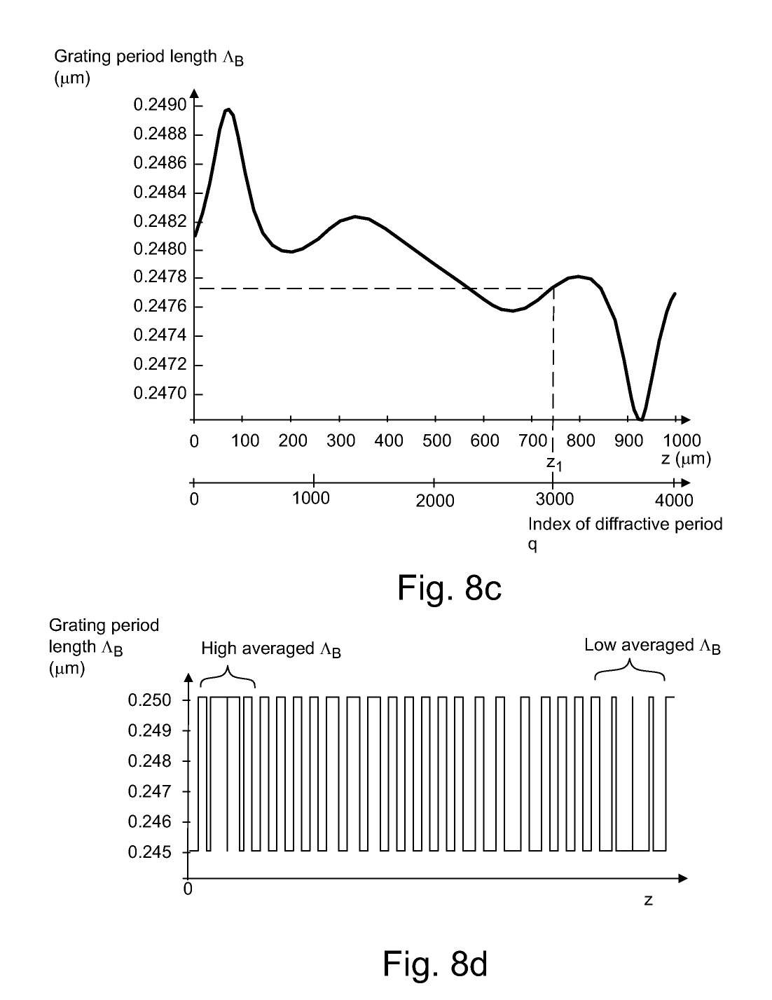

The period length Λ_{B} may also be expressed as a function of the index q of a grating period (FIG. 8c). The index q may specify the location of a grating period and/or the location of a diffractive feature 83.

A spectral reflectance band having a wide and flat top may be provided e.g. by using a grating G1, which has a first region REGB1, a second region REGB2, and a third region REGB3 such that:
in the first region REGB1, the length Λ_{B} of the period of the diffractive features 83 substantially increases with increasing distance z from an origin ORIG,
in the second region REGB2, the length Λ_{B} of the period of the diffractive features 83 substantially decreases with increasing distance z from the origin ORIG.
in the third region REGB3, the length Λ_{B} of the period of the diffractive features 83 substantially increases with increasing distance z from the origin ORIG.

The second region REGB2 may be located between the first region REGB1 and the third region REGB3.

Λ_{B,MAX} denotes the maximum value of the period of the diffractive features 83. z_{BMX} denotes the location where maximum value Λ_{B,MAX} is attained. Λ_{B,MIN} denotes the minimum value of the period of the diffractive features 83. z_{BMN} denotes the location where minimum value Λ_{B,MIN} is attained. Λ_{B,AVE} denotes the averaged value of all periods of the grating G1.

The position z_{BMX} may mark the boundary between the first region REGB1 and the second region REGB2. The position z_{BMN} may mark the boundary between the second region REGB2 and the third region REGB3.

A grating period function Λ_{B}(z) which at least approximately provides the desired spectral reflectance I_{R}(λ)/I₁(λ) may be determined by using an Iterative Fourier Transform Algorithm (IFTA).

The use of the Iterative Fourier Transform Algorithm IFTA is partially based on an observation that the spectral amplitude B(λ) of the reflected wave R1 and a coupling coefficient function κ_{BA}(z) may form a Fourier transform pair.

The input beam B1 may comprise one or more optical modes, the reflected beam R1 may comprise one or more optical modes, and also the transmitted beam BT may comprise one or more optical modes. In the following simplified discussion, each beam is considered to consist of a single mode. In the simplified situation, the input beam B1 may be called as the input wave or as the input mode. The reflected beam B1 may be called as the reflected wave or as the reflected mode. The transmitted beam may be called as the transmitted wave or as the transmitted mode.

The waveguide 92 perturbed by the grating G1 couples the input mode B1 to the reflected mode R1. The location-dependent coupling from the input mode B1 to the reflected mode R1 may be governed by a coupling coefficient function κ_{AB}(z). The form of the spectral reflectance function I_{R}(λ)/I₁(λ) depends on the location-dependent optical coupling between the input mode B1 and the reflected mode R1.

The coupling coefficient κ_{AB} may at least locally be approximated by a Fourier series

κ_{AB}(z)≈Σκ_{AB}⁽⁰⁾+κ_{AB}⁽¹⁾H_{G}(z)+κ_{AB}⁽²⁾H_{G}(2·z)+ . . . (2)

where κ_{AB}⁽⁰⁾, κ_{AB}⁽¹⁾, and κ_{AB}⁽²⁾ denote the zeroth, first and second Fourier coefficients and H_{G}(z) denotes a periodic function, which at least locally has the same period as the grating G1.

A(z) denotes the amplitude of the input wave B1 at a location z. B(z) denotes amplitude of a reflected wave R1 at a location z.

The first derivative of A(z) is given by the equation:

$$\frac{d A ( z )}{d z} = - i \cdot {κ}_{B A} ( z ) A ( z ) {e}^{i Δ k \cdot z} \qquad ( 3 a )$$

The first derivative of B(z) is given by the equation:

$$\frac{d B ( z )}{d z} = - i \cdot {κ}_{AB} ( z ) B ( z ) {e}^{i Δ k \cdot z} \qquad ( 3 b )$$

κ_{AB} denotes the coupling coefficient from the input mode to the reflected mode, κ_{BA}(z) denotes the coupling coefficient from the reflected mode to the input mode, and Δk denotes a phase vector difference:

$$Δ k = {β}_{0} + {κ}_{AB}^{( 0 )} - {β}_{B} - {κ}_{BA}^{( 0 )} \qquad ( 4 )$$

where β₀ denotes the component of the wave vector of the input wave in the direction of the z-axis, β_{R} denotes the component of the wave vector of the reflected wave in the direction of the z-axis, κ_{AB}⁽⁰⁾ denotes the zeroth (0th) Fourier coefficient of the coupling coefficient from the input wave to the reflected wave, and κ_{BA}⁽⁰⁾ denotes the zeroth (0th) Fourier coefficient of the coupling coefficient from the reflected wave to the input wave. The values of β₀ and β_{R} are given by:

$$\begin{matrix}{β}_{0} = \frac{2 π {n}_{eff}}{λ} & ( 5 a ) \\ {β}_{R} = \frac{2 π {n}_{eff}}{λ} & ( 5 b )\end{matrix}$$

where n_{eff} denotes the effective refractive index of waveguide 92 perturbed by the diffractive features 83 of the grating G1.

The coupling coefficient κ_{BA} may be calculated from the integral:

$${κ}_{BA} ( z ) = \frac{k}{4 {P}_{Z}} \sqrt{\frac{{ɛ}_{0}}{{μ}_{0}}} [ \begin{matrix}\begin{matrix}\int \int {E}_{xB}^{*} ( x , y ) Δ ɛ ( z ) {E}_{xA} ( x , y ) d x d y + \\ \int \int {E}_{yB}^{*} ( x , y ) Δ ɛ ( z ) EyA ( x , y ) d x d y +\end{matrix} \\ \int \int {E}_{xB}^{*} ( x , y ) \frac{{ɛ}_{C} ( x , y ) Δ ɛ ( z )}{{ɛ}_{C} ( x , y ) + Δ ɛ ( z )} {E}_{zA} ( x , y ) d x d y\end{matrix} ] \qquad ( 6 )$$

where ε_{c}(x,y) denotes the relative permittivity of the waveguide 92, Δε(z) denotes the periodic perturbation of permittivity of the waveguide 92 caused by the grating G1, x denotes a position coordinate in the direction SX, y denotes a position coordinate in the direction SY, and k denotes the wave vector (|k|=2π/λ). P_{z} denotes the z-component of the time-averaged Poynting vector, i.e. the component of the time-averaged Poynting vector, which is oriented in the direction SZ. E_{xB} denotes the component of the electric field of the reflected wave oriented in the direction SX, and E_{xA} denotes the component of the electric field of the input wave oriented in the

If reflection by the grating G1 does not significantly decrease the amplitude A(z), the amplitude of the reflected wave may be given by:

B(Δk)=−∫_{-∞}^{∞}iκ_{BA}(z)e^{iΔk·z}dz (7a)

and the coupling coefficient function κ_{BA} may be given by

$${κ}_{BA} ( z ) = \frac{1}{2 π} {\int }_{- ∞}^{∞} B ( Δ k ) {e}^{- i Δ k \cdot z} d Δ k . \qquad ( 7 b )$$

The equations (7a) and (7b) form a Fourier transform pair.

The functions κ_{BA}(z) and B(Δk) may be complex-valued. The amplitude B(Δk) is a function of a spectral position Δk. The coupling coefficient κ_{BA}(z) is a function of the spatial position z. The coupling coefficient function κ_{BA}(z) may have a location-dependent amplitude |κ_{BA}(z)|, and a location-dependent phase arg(κ_{BA}(z)). The function B(Δk) may have an amplitude |B(Δk)| and a phase arg(B(Δk)), which depend on the spectral position (spectral displacement) Δk. The spectral displacement Δk may be equal to a difference Δk=k−k₀, wherein k₀ denotes a central wavenumber k₀=2π/λ₀.

Based on the equation (7a), the amplitude function B(Δk) may be controlled in the spectral domain by controlling the phase of the coupling coefficient κ_{BA}(z) as a function of the location z.

The equation (7b) implies that when the diffractive features 83 of the grating G1 are shifted by a distance Δz, the phase of the reflected wave is shifted by the term ΔkΔz. Consequently, by locally controlling the positions of the diffractive features 83, we can also control the phase arg(κ_{BA}(z)) of the coupling coefficient κ_{BA} at the different longitudinal positions z.

Based on the equation (7b), the coupling coefficient function κ_{BA} may be approximated by a Fourier transform of the amplitude function B(Δk) of the reflected wave R1. Alternatively, the coupling coefficient function κ_{BA} may be approximated by an inverse Fourier transform of the amplitude function B(Δk).

The intensity I_{R}(λ) of the reflected wave R1 is proportional to the square of the amplitude B(λ):

I_{R}(λ)∝(B(λ))² (8a)

The amplitude |B(Δk)| of the amplitude function B(Δk) is proportional to the square root of the intensity I_{R}(λ), respectively:

|B(λ)|∝{square root over ((I_{R}(λ))} (8b)

Initially, the form of the desired spectral reflectance function I_{R}(λ)/I₁(λ) is known at least approximately. For determining the reflectivity, the intensity I₁(λ) of the input wave B1 may be assumed to be constant (i.e. independent of the wavelength λ). Thus, the amplitude |B(λ)| may be calculated from the desired spectral reflectance function I_{R}(λ)/I₁(λ):

$$\vert B ( λ ) \vert ∝ \sqrt{\frac{{I}_{R} ( λ )}{{I}_{1} ( λ )}} \qquad ( 8 c )$$

The relationship between the wavelength λ and the wave vector k is known:

$$\vert k \vert = \frac{2 π}{λ} \qquad ( 8 d )$$

The amplitude |B(Δk)| of the amplitude function B(Δk) of the reflected wave R1 may be calculated from the spectral reflectance function I_{R}(λ)/I₁(λ) by using the equations (8c) and (8d).

The spectral reflectance I_{R}(λ)/I₁(λ) may also be expressed as a function of the variable Δk, i.e. in the form I_{R}(k₀+Δk)/I₁(k₀+Δk) or in the form I_{R}(Δk)/I₁(Δk). Based on the equations (7a) and (8a) we may derive that:

$$\frac{{I}_{R} ( Δ k )}{{I}_{1} ( Δ k )} ∝ {\vert {\int }_{- ∞}^{∞} i {κ}_{BA} ( z ) {e}^{i Δ k \cdot z} d z \vert}^{2} \qquad ( 8 e )$$

Equation (8e) states that the spectral reflectance function I_{R}(Δk)/I₁(Δk) may substantially correspond to a function, which is equal to the square of the absolute value of the inverse Fourier transform of the coupling coefficient function κ_{BA}(z).

In particular, equation (8e) states that the spectral reflectance function I_{R}(Δk)/I₁(Δk) may be (substantially) proportional to a function, which is equal to the square of the absolute value of the inverse Fourier transform of the coupling coefficient function κ_{BA}(z).

The local period length Λ_{B}(z) may be selected such that a deviation ΔΛ_{B}(z) from the average period length Λ_{B,AVE} (of all periods of the grating G1) at each location z is proportional to the phase arg(κ_{BA}(z)). The grating period function Λ_{B}(z) may be calculated from the phase arg(κ_{BA}(z)) of the coupling coefficient function κ_{BA}(z), e.g. as follows:

Λ_{B}(z)=Λ_{B,AVE}+ΔΛ_{B}(z) (9a)

ΔΛ_{B}(z)=coef₁·arg(κ_{BA}(z)) (9b)

A suitable value for the coefficient coef₁ may be, for example:

$${coef}_{1} = \pm \frac{{Λ}_{B , AVE}}{2 π} \qquad ( 9 c )$$

The average period length Λ_{B,AVE} of the grating G1 may be selected according to the central wavelength λ₀ of the desired spectral reflectance curve I_{R}(λ)/I₁(λ).

Referring to FIGS. 6b and 6c, w₁ denotes the width of a diffractive feature 83, and w₂ denotes the width of a space between two adjacent diffractive features 83 (in the direction SZ). In particular, w₁ may denote the width of a diffractive ridge, and w₂ may denote the width of a diffractive groove. The grating period Λ_{B} is equal to the sum w₁+w₂. The duty cycle w₁/Λ_{B} is the (local) ratio of the width w₁ to the (local) length Λ_{B} of the grating period. The duty cycle function w₁(z)/Λ_{B}(z) defines the local value of the duty cycle as a function of the position z.

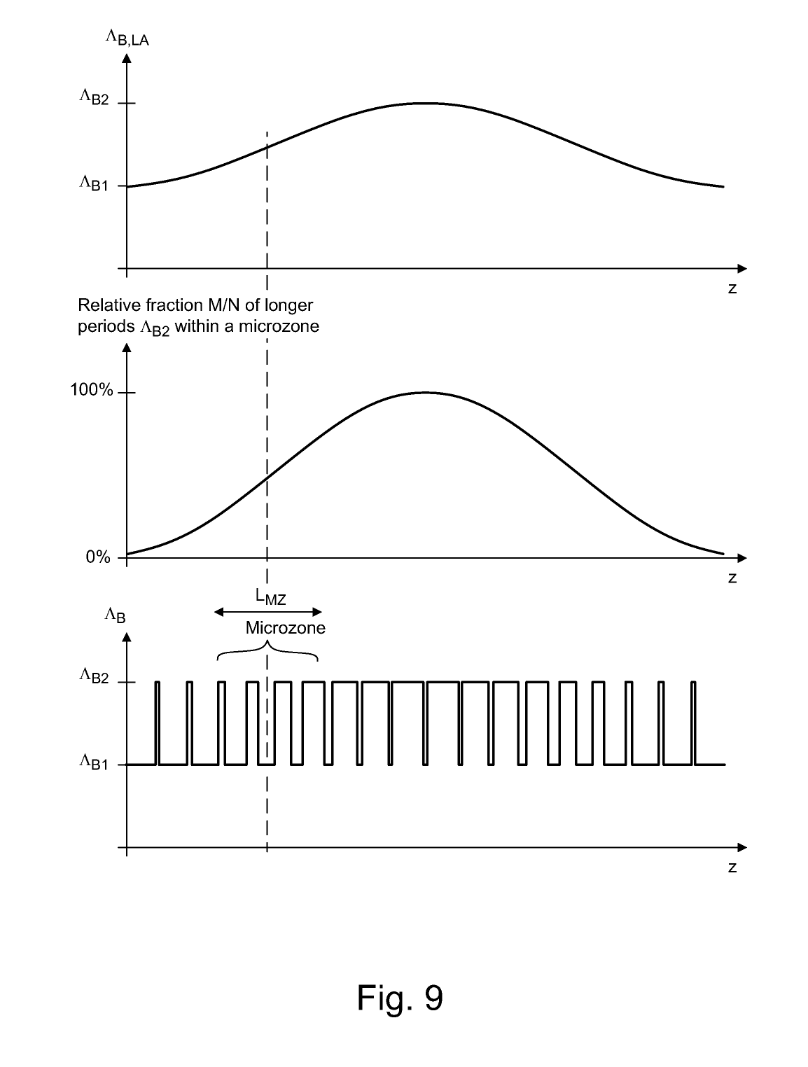

Referring to FIG. 6b, the duty cycle function may be substantially constant. For example, the duty cycle may be e.g. substantially equal to 50% at all locations z of the grating. In case of a quantized period length, the period length may have abrupt changes (se FIG. 9). TP denotes a transition point (transition plane) where period length Λ_{B} is abruptly changed. In fact, TP is a plane defined by the directions SX and SY.

Referring to FIG. 6c, the duty cycle may also be a (non-constant) function of the grating period function Λ_{B}(z). In particular, the duty cycle may be a linear function of the grating period function Λ_{B}(z). In particular, one of the widths w₁ and w₂ may remain substantially constant even when the value of the grating period function Λ_{B}(z) varies. This may facilitate manufacturing of the grating G1.

Typically, the phase arg(κ_{BA}(z)) of the coupling coefficient function κ_{BA}(z) and the phase arg(B(Δk)) of the amplitude function B(Δk) are not known at the initial stage of the calculations.

Calculation of the grating period function Λ_{B}(z) from the equation (9a) requires knowledge about the phase arg(κ_{BA}(z)). The phase arg(κ_{BA}(z)) may be solved e.g. from the equation (7b), but the direct calculation requires knowledge about the amplitude |B(Δk)| and the phase arg(B(Δk)).

The phase of the complex-valued function κ_{BA}(z) cannot be directly solved by using the equation (7b) if the phase arg(B(Δk)) is unknown. In this case, the solution for a problem defined with the pair of equations (7a) and (7b) is not uniquely defined, and cannot be typically solved by a direct calculation. However, the phases arg(κ_{BA}(z)) and arg(B(Δk)) may be iteratively solved by using a phase-retrieval algorithm known as the Iterative Fourier Transform Algorithm (IFTA).

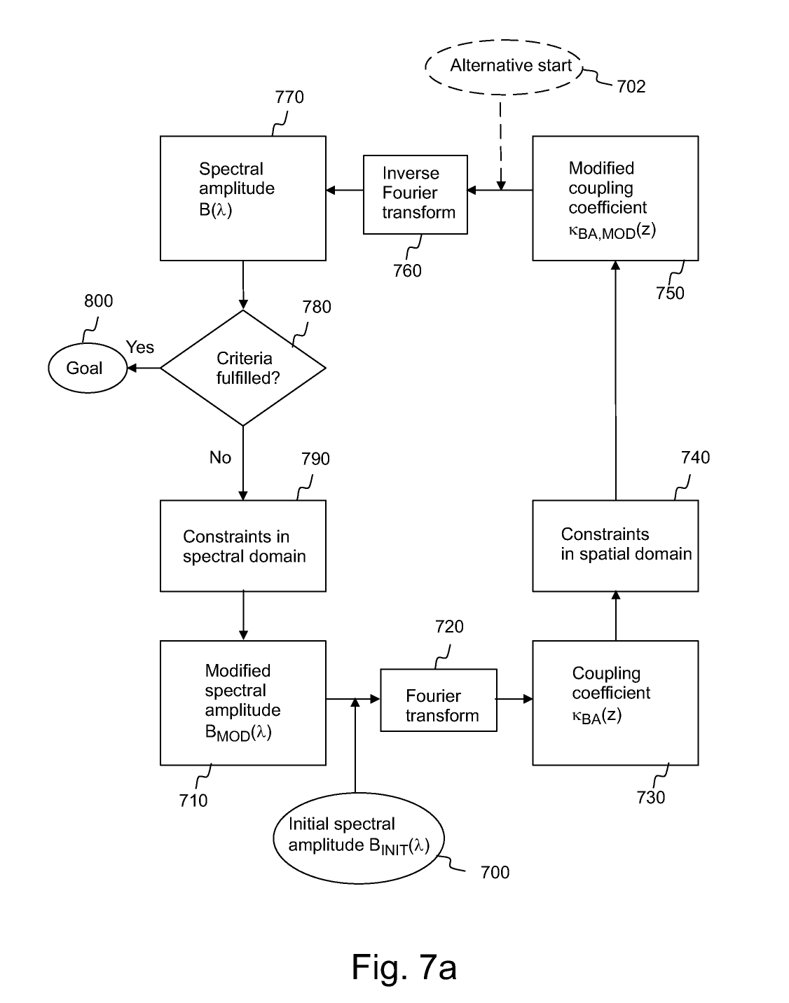

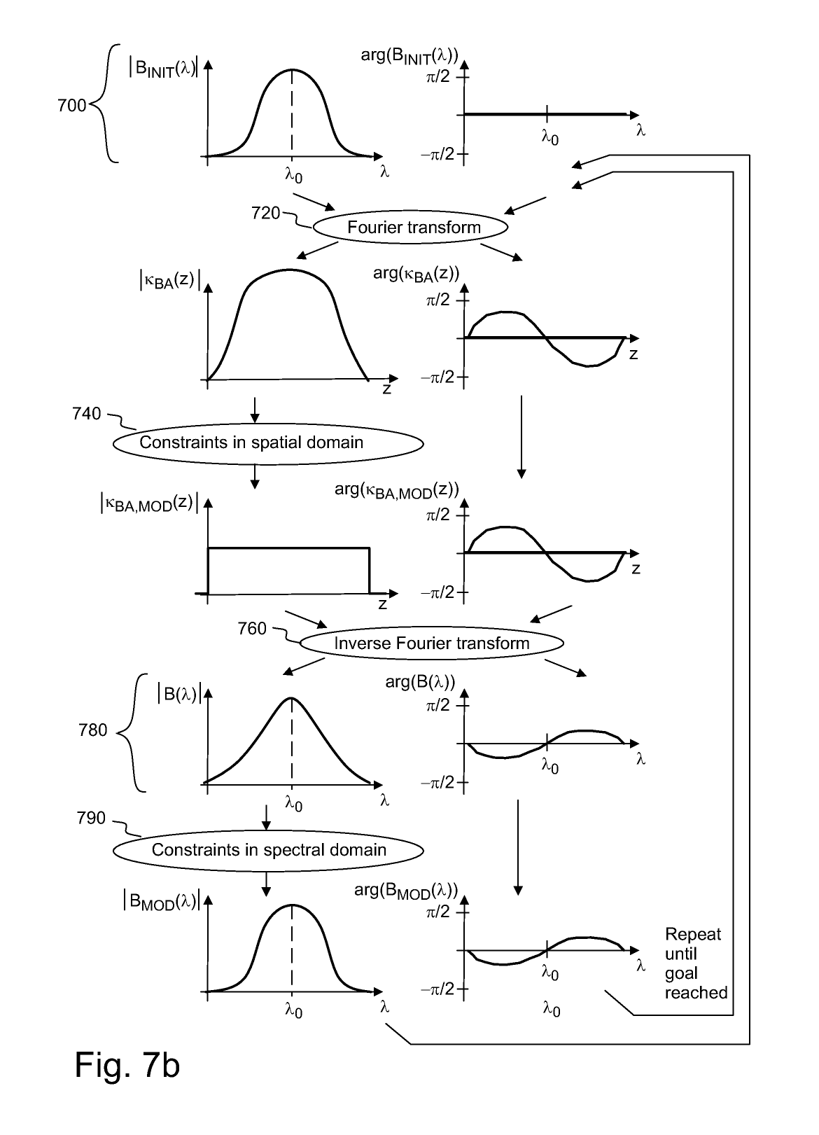

FIGS. 7a and 7b show steps of an Iterative Fourier Transform Algorithm (IFTA). In the step 700, the algorithm may be started by taking an initial guess B_{INIT}(λ) for the spectral amplitude function B(λ) of the reflected wave R1. For example, the phase arg(B(λ)) may be initially set to zero, and the amplitude |B(λ)| may be calculated e.g. from the equation (8c). Referring to the equation (8d), the spectral amplitude function B(λ) may be expressed as a function of the wavelength λ or as a function of the spectral shift Δk.

A first estimate for the coupling coefficient function κ_{BA}(z) may be determined by calculating a Fourier transform of the initial function B_{INIT}(λ) in step 720.

The estimate of the coupling coefficient function κ_{BA}(z) may correspond to a grating G1 which difficult or impossible to produce in practice. The amplitude of the coupling coefficient function κ_{BA}(z) obtained after the transform step 720 may be modified e.g. in order to facilitate manufacturing of the grating G1.

A modified coupling coefficient function κ_{BA,MOD}(z) may be determined from the estimate κ_{BA}(z) in the step 740. Suitable spatial constraints may be taken into account. In the step 740, (only) the amplitude |κ_{BA}(z)| may be modified, e.g. in order to facilitate manufacturing of the grating G1. For example, the amplitude |κ_{BA,MOD}(z)| of the modified coupling coefficient function κ_{BA,MOD}(z) may set to be equal to a predetermined function u(z). The function u(z) may be e.g. substantially equal to a constant function (i.e. u(z)=c₁). The function u(z) may be e.g. substantially equal to a linear function (i.e. u(z)=c₁+c₂·z).

The function u(z) may also be e.g. substantially equal to an exponential function (i.e. u(z)=e^{s·z}). The exponential function may be an exponentially decreasing or increasing function.

The function u(z) may also be e.g. substantially equal to a linear combination of a linear function and an exponential function (i.e. u(z)=c₁+c₂·z+e^{s·z}). The parameters c₁, c₂ and s are constants.

The modification may also be gradual, i.e. the function u(z) may be e.g. substantially equal to a linear combination of the amplitude |κ_{BA}(z)| (obtained by calculating a Fourier transform of the function B_{INIT}(λ) or B_{MOD}(λ)) and a function selected from the group of c₁, c₁+c₂·z, e^{s·z}, c₁+c₂·z+e^{s·z}). For example, the function u(z) may be equal to c₁+c₃·|κ_{BA}(z)|, wherein the parameter c₃ may be e.g. greater than 0 and smaller than 1.

The amplitude of the input beam B1 may depend on the position z. In an embodiment, this effect may be taken into consideration e.g. by using the (correction) function u(z) in the modification step 740. For example, the amplitude |κ_{BA}(z)| obtained by the transform step 720 may be replaced in the step 740 e.g. with the function u(z). The function u(z) may be e.g. one of the functions listed above.

A suitable function u(z) may also be determined by numerical optimization. For example, the suitable (optimum) form of the function u(z) may be determined by determining a first grating period function by using a first function u(z) in the iterative Fourier transform algorithm, and by determining a second grating period function by using a second (different) function u(z) in the iterative Fourier transform algorithm. Now, it may be experimentally or theoretically tested whether the use of said first function u(z) or the use of said second function u(z) provides a closer match between the desired spectral reflectance and the attained spectral reflectance.

Once a poling period function has been determined by using the iterative Fourier transform algorithm, a spectral reflectance provided by said poling period function may be calculated e.g. by using the technique called as the rigorous coupled-wave analysis of grating diffraction.

Typically, there is no need to modify the phase arg(κ_{BA}(z)) provided by the Fourier transform step 720. The modified coupling coefficient function κ_{BA,MOD}(z) may have the same phase (or substantially similar phase) as the coupling coefficient function κ_{BA}(z). In other words, the phase arg(κ_{BA,MOD}(z)) provided by the modification step 740 may be substantially equal to the phase arg(κ_{BA}(z)) provided by the Fourier transform step 720.

In the step 760, an amplitude function B(λ) may be determined by calculating an inverse Fourier transform of the modified coupling coefficient function κ_{BA,MOD}(z).

The function B(λ) obtained by the inverse Fourier transform may be evaluated in the step 780. In particular, the amplitude |B(λ)| obtained by the inverse Fourier transform may be compared with the amplitude |B(λ)| calculated from the desired spectral reflectance function by using the equation (8c).

If the selected criteria are fulfilled, the algorithm may be stopped in the step 800.

If the criteria are not fulfilled, a modified spectral amplitude B_{MOD}(λ) may be determined from the function B(λ) obtained by the inverse Fourier transform. The modified spectral amplitude B_{MOD}(λ) is provided in step 790

In step 790, the amplitude |B(λ)| of the amplitude function B(λ) obtained by the step 760 may be adjusted so as to form a modified amplitude function B_{MOD}(λ). In particular, the amplitude |B(λ)| obtained by the inverse Fourier transform may be replaced with the initial amplitude function |B_{INIT}(λ)| calculated from the desired spectral reflectance by the equation (8c). In other words, the amplitude of the modified amplitude function |B_{MOD}(λ)| may be substantially equal to the amplitude of the initial amplitude function |B_{INIT}(λ)|.

Typically, there is no need to modify the phase arg(B(λ)) provided by the Fourier transform step 720. In other words, the modified amplitude function B_{MOD}(λ) may have the same phase arg(B(λ)) (or substantially similar phase) as the amplitude function B(λ) obtained by the step 760.

Now, a new estimate for the coupling coefficient function κ_{BA}(z) may be determined by calculating a Fourier transform of the modified function B_{MOD}(λ) obtained after the modification step 790.

The transform step 720, the modification step 740, the transform step 760, the evaluation step 780 and modification step 790 may be repeated in successive order until the selected criteria are fulfilled.

The amplitude function B(λ) (or B(Δk)) obtained after the transform step 760 may be evaluated in step 780 by checking one or more criteria. If the criteria are fulfilled, the algorithm may be stopped in step 800. If the criteria are not fulfilled, the algorithm may be continued with new iteration cycle.

For example, the steps 790, 720, 740, 760, and 780 may be repeated until the width Δλ_{80%} of the spectral reflectance function is greater than a predetermined value and/or until the depth of depression ΔR_{DEP} is smaller than a predetermined value.

For example, the width Δλ_{80%} may be compared with a reference value in step 780. The iteration may be stopped when the width Δλ_{80%} is greater than or equal to a predetermined value and/or until the depth of depression ΔR_{DEP} (FIG. 5) is smaller than a predetermined value. For example the ratio Δλ_{80%}/Δλ_{FWHM} may be compared with a reference value in step 780. The iteration may be stopped when the ratio Δλ_{80%}/Δλ_{FWHM} is greater than or equal to a predetermined value.

The magnitude of the adjustments made in the steps 740 and 790 may be limited such that the algorithm converges to a solution.

Smoothness of the result (i.e. smoothness of the spectral amplitude function B(λ) and/or convergence of the iterative algorithm IFTA may be enhanced by allowing small perturbations in the coupling coefficient function κ_{BA}(z).

The modifications made in the steps 740 and/or 790 may be gradual so as to ensure convergence of the algorithm.

Principles and convergence of an iterative Fourier transform algorithm have been discussed e.g. in an article “Iterative Fourier-transform algorithm applied to computer holography, by F. Wyrowski and O. Bryngdahl, in J. Opt. Soc. Am A 5, pp. 1058-1064 (1988).

The solving the phase arg(κ_{BA,MOD}(z)) may require repeating the iteration cycle two or more times. For example, 10 to 1000 iteration cycles may be carrier out until the selected criteria are fulfilled. A single iteration cycle may comprise at least a Fourier transform step 720, an inverse Fourier transform step 760, and at least one of the modification steps 740, 790. A single iteration cycle may comprise at least a Fourier transform step 720, an inverse Fourier transform step 760, and the modification steps 740, 790.

The algorithm may also be started e.g. by taking an initial guess κ_{BA,INIT}(z) for the coupling coefficient function κ_{BA}(z) in step 702.

Alternatively, in the transform step 720, an inverse Fourier transform may be calculated, and in the transform step 760, a Fourier transform may be calculated.

In practice, the Fourier transform may be determined by calculating a Discrete Fourier transform (DFT). The inverse Fourier transform may be determined by calculating a Discrete Inverse Fourier transform (DFT⁻¹).

In step 730, a coupling coefficient function κ_{BA}(z) obtained after the Fourier transform step 720 may be stored in a memory. In step 750, a modified coupling coefficient function κ_{BA,MOD}(z) may be stored in a memory. In step 770, an amplitude function B(λ) obtained after the inverse Fourier transform step 760 may be stored in a memory. In step 710, a modified amplitude function B_{MOD}(λ) may be stored in a memory.

As the result, the Iterative Fourier Transform Algorithm may provide a phase function arg(κ_{BA}(z)) which allows calculation of the grating period function Λ_{B}(z) according to the equations (9a) and (9b).

As the result, the Iterative Fourier Transform Algorithm may provide the phase arg(κ_{BA}(z)) such that the Fourier transform of the (complex-valued) coupling coefficient function κ_{BA}(z) substantially corresponds to the desired spectral reflectance function I_{R}(λ)/I₁(λ). The relationship between the functions κ_{BA}(z) and I_{R}(λ)/I₁(λ) may be obtained e.g. based on the equations (7a) and (8a).

As the result, the Iterative Fourier Transform Algorithm may provide the phase arg(κ_{BA}(z)) such that a grating G1 implemented according to the equations (9a) and (9b) provides a desired spectral reflectance fulfilling one or more of the predetermined criteria.

Referring back to FIG. 5, the criteria for the desired spectral reflectance may be e.g. one or more of the following:

The width Δλ_{FWHM} may be e.g. greater than or equal to 0.5 nm, advantageously greater than or equal to 1.0 nm.

The width Δλ_{80%} may be e.g. greater than the width Δλ_{FWHM} multiplied by 0.6. Advantageously, width Δλ_{80%} is greater than the width Δλ_{FWHM} multiplied by 0.7. Preferably, the width Δλ_{80%} is greater than the width Δλ_{FWHM} multiplied by 0.8.

The width Δλ_{95%} may be e.g. greater than the width Δλ_{FWHM} multiplied by 0.6. Advantageously, width Δλ_{95%} is greater than the width Δλ_{FWHM} multiplied by 0.7. Preferably, the width Δλ_{95%} is greater than the width Δλ_{FWHM} multiplied by 0.8.

The fluctuations ΔR_{DEP} in the vicinity of the central wavelength λ₀ may be e.g. smaller than 10% of the maximum value MAXV. Advantageously, the fluctuations ΔR_{DEP} in the vicinity of the central wavelength λ₀ may be e.g. smaller than 5% of the maximum value MAXV. Preferably, fluctuations ΔR_{DEP} in the vicinity of the central wavelength λ₀ may be e.g. smaller than 3% of the maximum value MAXV

One or more of the above-mentioned criteria may be applied e.g. in the evaluation step 780 of the algorithm IFTA.

When the algorithm has converged, the grating period function Λ_{B}(z) of the grating G1 may substantially correspond to the phase arg((κ_{BA}(z)) of a coupling coefficient function κ_{BA}(z), wherein the coupling coefficient function κ_{BA}(z) is obtained by calculating a Fourier transform of the square root of the spectral reflectance I_{R}(λ)/I₁(λ).

The grating period function Λ_{B}(z) of the grating G1 may substantially correspond to the phase arg((κ_{BA}(z)) of a coupling coefficient function κ_{BA}(z), wherein the coupling coefficient function κ_{BA}(z) has been determined such that the spectral reflectance function I_{R}(Δk)/I₁(Δk) is substantially proportional to a function, which is equal to the square of the absolute value of the inverse Fourier transform of the coupling coefficient function κ_{BA}(z).

The grating period function Λ_{B}(z) of the grating G1 may substantially correspond to the phase arg((κ_{BA}(z)) of a coupling coefficient function κ_{BA}(z), wherein the coupling coefficient function κ_{BA}(z) is obtained by calculating a Fourier transform of the square root of the spectral reflectance I_{R}(λ)/I₁(λ).

The grating period function Λ_{B}(z) of the grating G1 may substantially correspond to the phase arg((κ_{BA}(z)) of a coupling coefficient function κ_{BA}(z), wherein the coupling coefficient function κ_{BA}(z) has been determined such that the spectral reflectance function I_{R}(Δk)/I₁(Δk) substantially corresponds to a function, which is equal to the square of the absolute value of the inverse Fourier transform of the coupling coefficient function κ_{BA}(z).

The grating period function Λ_{B}(z) of the grating G1 may substantially correspond to the phase arg((κ_{BA}(z)) of a coupling coefficient function κ_{BA}(z), wherein the coupling coefficient function κ_{BA}(z) is obtained by calculating a Fourier transform of a shape function S(λ), which corresponds to the spectral reflectance I_{R}(λ)/I₁(λ). The (spectral) shape function S(λ) may be equal to √(I_{R}(λ)/I₁(λ)), for example.

The grating period function Λ_{B}(z) of the grating G1 may substantially correspond to the phase arg((Λ_{BA}(z)) of a coupling coefficient function κ_{BA}(z), wherein the coupling coefficient function κ_{BA}(z) has been determined such that a shape function S(λ) substantially corresponds to a function, which is equal to the square of the absolute value of the inverse Fourier transform of the coupling coefficient function Λ_{BA}(z), and wherein the shape function S(λ) substantially corresponds to the spectral reflectance I_{R}(λ)/I₁(λ) of the grating G1. The (spectral) shape function S(λ) may be equal to √(I_{R}(λ)/I₁(λ)), for example.

In some cases, there may be a tradeoff between the height H_{SIDE} of the sidebands and the magnitude ΔR_{DEP} of the fluctuations in the vicinity of the central wavelength λ₀. For example, in some cases, the height H_{SIDE} of the sidebands may be reduced by allowing larger fluctuations ΔR_{DEP} in the vicinity of the central wavelength λ₀. The criteria for the desired spectral reflectance may be selected according to the application.

FIG. 8a shows a spectral reflectance provided by a grating G1, whose grating period function Λ_{B}(z) is calculated from the phase arg(κ_{BA}(z)) determined by using the Iterative Fourier Transform Algorithm. The length L_{B} of the grating is 1 mm (=1000 μm).

The spectral reflectance curve of FIG. 8a is substantially broader than the spectral reflectance curve of FIG. 2. The curve of FIG. 8a also has a substantially flat top when compared with the curve of FIG. 2.

FIG. 8b shows the phase arg(κ_{BA}(z)) corresponding to the spectral reflectance of FIG. 8a.

FIG. 8c shows the grating period function Λ_{B}(z) calculated from the phase arg(κ_{BA}(z)) of FIG. 8b.

The period length Λ_{B} may be expressed as a function of the position z. The position coordinate may define e.g. the distance of a position from an origin. For example the period length Λ_{B} may be equal to 0.24772 at the position z₁=750 μm.

Alternatively, the position may be defined by specifying an index q of a diffractive period (e.g. the 3000th period from the origin). For example the period length Λ_{B} may be equal to 0.24772 at the position q=3000.

The practical implementation of the period length distribution Λ_{B}(z) shown in FIG. 8c may require very high manufacturing accuracy.

Referring to FIGS. 8d and 9, the period lengths Λ_{B} may be quantized in order to facilitate manufacturing of the grating G1.

FIG. 8d shows the period lengths Λ_{B} as a function of position z when using only two different period lengths Λ_{B}, namely 245 nm and 250 nm. The period lengths Λ_{B} may be quantized in order to facilitate manufacturing of the grating G1. The grating G1 may be produced e.g. by using N_{Λ} different period lengths Λ_{B}, wherein N_{Λ} may be an integer in the range of 2 to 10. In particular, the grating G1 may be produced e.g. by using only two different period lengths Λ_{B}. The difference between the period lengths Λ_{B} may be e.g. 5 nm. The difference between the quantized period lengths Λ_{B} may be e.g. in the range of 0.5% to 4% of the average grating period.

This kind of a structure may be rather easily manufactured by lithography, without a need to fine-tune the widths of lithographic masks with extreme accuracy.

Referring to FIG. 9, the desired spectral reflectance function may be provided by using two different period lengths Λ_{B1} and Λ_{B2}. In this case, the local average Λ_{B,LA} of the period length Λ_{B} may be spatially varied such that the desired spectral reflectance function may be provided. Instead of varying the lengths of individual periods in a smooth manner, the local average Λ_{B,LA} of the period length Λ_{P} may be varied. The local average of the period length Λ_{B} may be spatially varied such that a desired spectral reflectance curve R(λ) may be provided. The local average Λ_{B,LA} at a position z may be substantially equal to the value of continuously varying period length Λ_{B} at the position z.

The local average Λ_{B,LA} in the vicinity of a position z may be determined e.g. by calculating the average value of the lengths of N_{LOC} successive periods in the vicinity of the position z. The integer N_{LOC} may be e.g. in the range of 2 to 100. In particular, the local average Λ_{B,LA} may be determined e.g. by calculating the average value of the lengths Λ_{B} of one hundred successive periods.

The group of N_{LOC} successive periods may be called as a microzone. The length L_{MZ} of the microzone may be approximately equal to N_{LOC}×Λ_{B,AVE}, where Λ_{B,AVE} denotes the global average of all periods of the grating G1. The length L_{MZ} may also be called as the length of the averaging window.

The length Λ_{B} of an individual grating period may be in the order of 0.25 μm (FIGS. 8c and 8d). The length of two periods may be substantially equal to 0.5 μm, and the length of 100 periods may be substantially equal to 25 μm. The length L_{MZ} of the averaging window may be e.g. in the range of 0.5 μm to 5 μm (2 to 20 periods). The length L_{MZ} of the averaging window may be e.g. in the range of 5 μm to 25 μm (20 to 100 periods).

Two different period lengths Λ_{B1} and Λ_{B2} may be applied within a microzone The number M_{LOC} of periods having the longer period length Λ_{B2} within the microzone may be selected such that the local average Λ_{B,LA} reaches the desired value. The ratio M_{LOC}/N_{LOC} may be in the range of 0 to 100%.

Three or more different period lengths may be applied within a microzone, and the number of periods having the different lengths within a single microzone may be selected such that the local average Λ_{B,LA} corresponds to the value of a continuous period length function ΛB(λ) obtained from the algorithm IFTA.

The number N_{Λ} of different period lengths applied within a single microzone may be substantially smaller than N_{LOC}.

Thus, the local average Λ_{B,LA} may be varied as a function of the distance z from the origin ORIG, instead of varying the period length Λ_{B} of individual grating periods. For example, in case of the FIG. 6a, the grating period function Λ_{B}(z) may be replaced with the local average function Λ_{B,LA}(z). The local average function Λ_{B,LA}(z) defines the average values of the lengths Λ_{B} at different distances z from the origin ORIG.

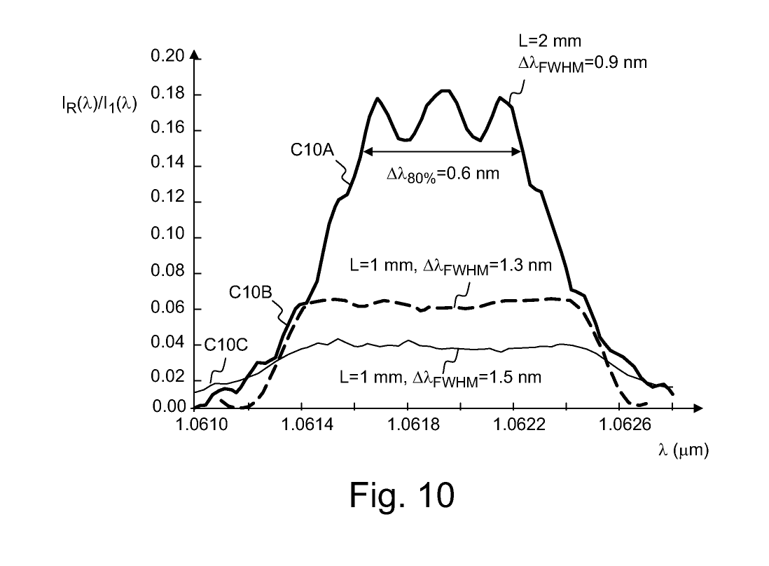

FIG. 10 shows, by way of example, spectral reflectance I_{R}(λ)/I₁(λ) for three different gratings.

The curve C10A shows spectral reflectance for a grating G1 whose length L is equal to 2 mm. The spectral width Δλ_{FWHM} of the curve C10A is equal to 0.9 nm. The spectral width Δλ_{80%} of the curve C10A is equal to 0.6 nm. The curve C10B shows spectral reflectance for a grating G1 whose length L is equal to 1 mm. The spectral width Δλ_{FWHM} of the curve C10B is equal to 1.3 nm. The curve C10C shows spectral reflectance for a grating G1 whose length L is equal to 1 mm. The spectral width Δλ_{FWHM} of the curve C10C is equal to 1.5 nm.

It may be noticed that the reflectance curves C10A, C10B, C10C implemented according to the invention may have a broad spectral width and a relatively flat top.

In fact, widening the spectral reflectance band may make it easier to determine the corresponding period length function Λ_{B}(z) by using the algorithm IFTA.

Widening of the spectral reflectance band may decrease the maximum reflectance. The decrease in the maximum reflectance may be compensated e.g. by increasing the height of the diffractive features 83 of the grating G1.

The height of the diffractive features 83 may also be increased in order to implement a shorter grating G1, which has a wide reflection bandwidth.

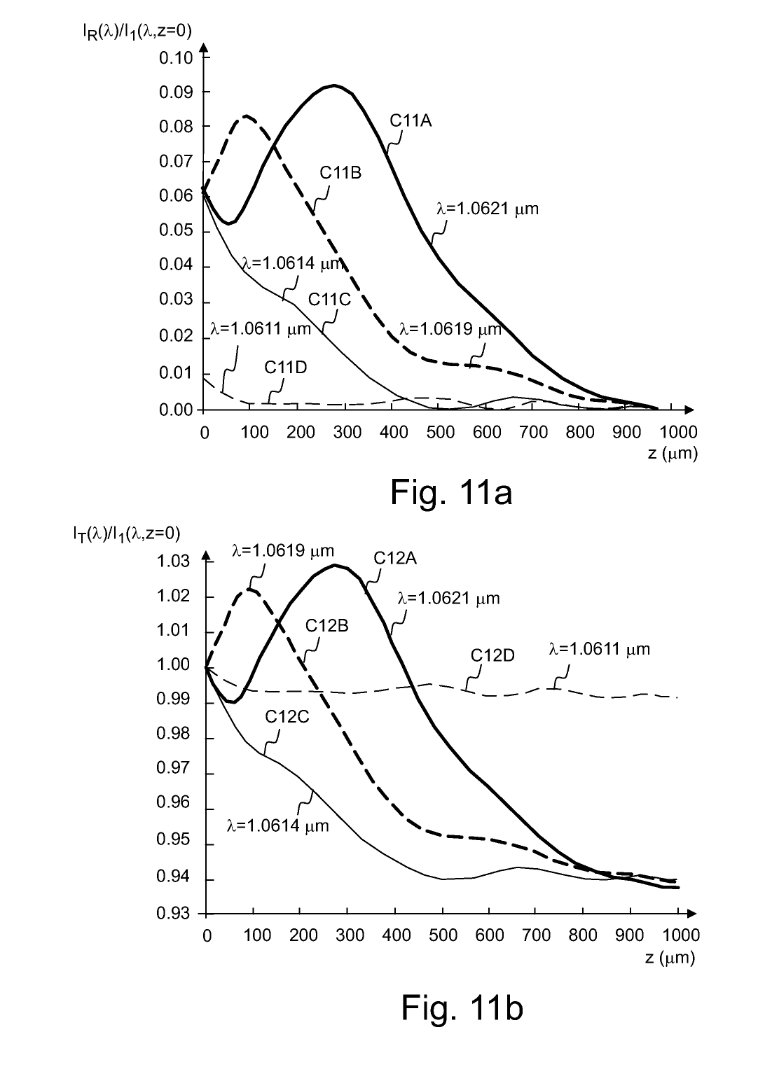

FIG. 11a shows the normalized intensity I_{R}(λ)/I₁(λ) of reflected light R1 as a function position z at four discrete wavelengths. The normalizing constant I₁(λ,z=0) is equal to the intensity of input light I1 at the location z=0 and at the wavelength λ. The curve C11A is determined at the wavelength λ=1.0621 μm. The curve C11B is determined at the wavelength λ=1.0619 μm. The curve C11C is determined at the wavelength λ=1.0614 μm. The curve C11D is determined at the wavelength λ=1.0611 μm.

FIG. 11b shows the normalized intensity I_{T}(λ)/I₁(λ,z=0) of transmitted light BT as a function of the position z at four discrete wavelengths. The curve C12A is determined at the wavelength λ=1.0621 μm. The curve C12B is determined at the wavelength λ=1.0619 μm. The curve C12C is determined at the wavelength λ=1.0614 μm. The curve C12D is determined at the wavelength λ=1.0611 μm.

At the location z=0, the intensity I₁(λ) of the transmitted light BT may be equal to the intensity I_{T}(λ) of transmitted light BT.

In case of FIGS. 11a and 11b, the central wavelength λ₀ of the spectral reflectance curve R(λ) is equal to 1.0619 nm.

For wavelengths close to the central wavelength λ₀, the transmitted intensity I_{T}(λ) and the reflected intensity I_{R}(λ) may be reduced at positions which are far from the input side of the grating G1.

For wavelengths, which substantially deviate from the central wavelength λ₀, the transmitted intensity I_{T}(λ) may remain at a high level at positions which are far from the input side of the grating G1.

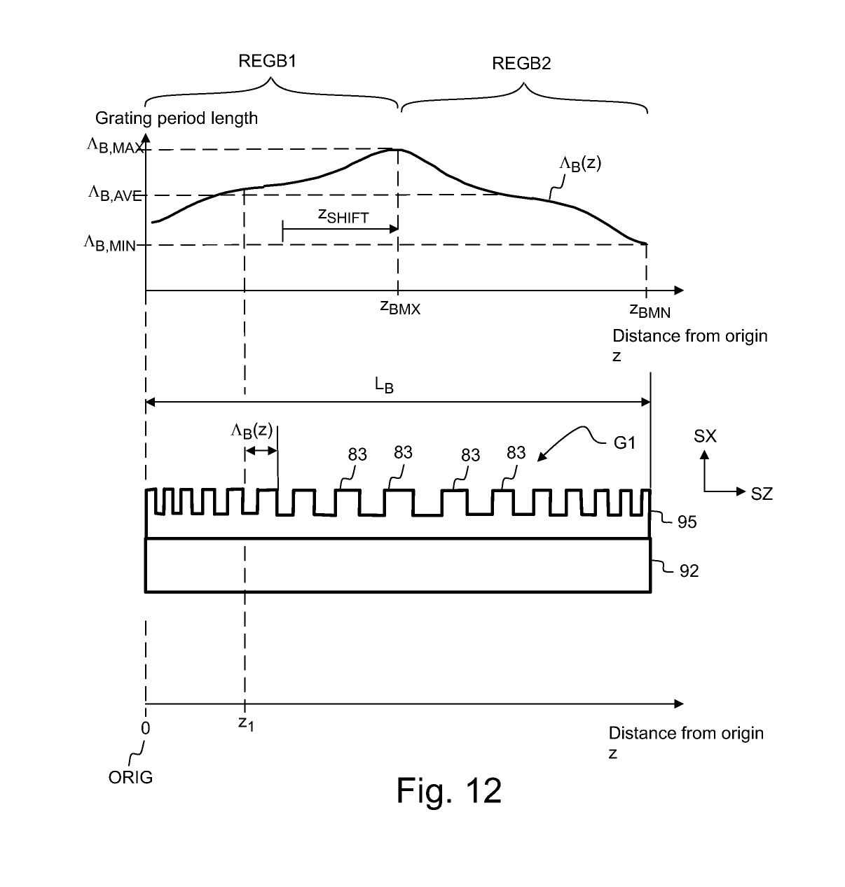

Referring to FIG. 12, a grating period function Λ_{B}(z) providing the desired spectral reflectance function may be cyclically shifted by a distance z_{SHIFT} and/or flipped without substantially changing the resulting spectral reflectance function.

Thus, a first grating period function Λ_{B}(z) obtained by the algorithm IFTA may also be shifted cyclically sideways by a length Z_{SHIFT} so as to provide a second grating period function Λ′_{B}(z), e.g. as follows:

Λ′_{B}(z)=Λ_{B}(z−z_{SHIFT}) when z−z_{SHIFT}<L_{B} (10a)

Λ′_{B}(z)=Λ_{B}(z−z_{SHIFT}−L_{B}) when z−z_{SHIFT}≧L_{B} (10b)

A grating G1 whose period length is varied according to the second grating period function Λ′_{B}(z) may provide a substantially similar (even identical) spectral reflectance as a grating (G1) whose period length is varied according to the first grating period function Λ_{B}(z).

As a result of the shifting, a grating which has three regions REGB1, REGB2, REGB3 (FIG. 6a) may be replaced with a grating which has only two regions REGB1, REGB2 (FIG. 12).

The grating G1 may have a first region REGB1 and a second region REGB2 such that:
in the first region REGB1, the length Λ_{B} of the period of the diffractive features 83 substantially increases with increasing distance z from an origin ORIG, and
in the second region REGB2, the length Λ_{B} of the period of the diffractive features 83 substantially decreases with increasing distance z from the origin ORIG.

It may be noticed that if the grating period function Λ_{B}(z) shown in FIG. 12 is cyclically shifted (approximately) by a distance L_{B}/2, the resulting grating G1 may have a first region REGB1 and a second region REGB2 such that:
in the first region REGB1, the length Λ_{B} of the period of the diffractive features 83 substantially decreases with increasing distance z from an origin ORIG, and
in the second region REGB2, the length Λ_{B} of the period of the diffractive features 83 substantially increases with increasing distance z from the origin ORIG.

As mentioned above, the grating period function may also be flipped, i.e. a first grating period function Λ_{B}(z) may be replaced with a second grating period function Λ″_{B}(z) as follows:

Λ″_{B}(z)=Λ_{B}(L_{B}−z) (10c)

A grating (G1) whose period length is varied (spatially modulated) according to the flipped grating period function Λ″_{B}(z) may provide a substantially similar (even identical) spectral reflectance R(λ) as a grating G1 whose period length is varied according to the first period length function Λ_{B}(z).

Consequently, the order of the grating regions REGB1, REGB2 and REGB3 shown in FIG. 6a may be reversed.

The position of the origin ORIG may be changed from the input end of the grating to the output end of the grating. Also this operation may correspond to flipping the grating period function. In other words, the flipping of the grating period function may be carried out by changing the position of the origin ORIG from the input end of the grating to the output end of the grating.

Thus, instead of the order shown in FIG. 6a, the grating G1 may have a first region REGB1, a second region REGB2, and a third region REGB3 such that:
in the first region REGB1, the length Λ_{B} of the period of the diffractive features 83 substantially decreases with increasing distance z from an origin ORIG,
in the second region REGB2, the length Λ_{B} of the period of the diffractive features 83 substantially increases with increasing distance z from the origin ORIG.
in the third region REGB3, the length Λ_{B} of the period of the diffractive features 83 substantially decreases with increasing distance z from the origin ORIG.

The length of the first region REGB1 may be e.g. greater than or equal to 5% of the total length L_{B} of the grating G1. The length of the second region REGB2 may be e.g. greater than or equal to 5% of the total length L_{B} of the grating G1. If the grating comprises the third region REGB3, the length of the region REGB3 may be e.g. greater than or equal to 5% of the total length L_{B} of the grating G1.

The length of the first region REGB1 may be e.g. greater than or equal to 20% of the total length L_{B} of the grating G1. The length of the second region REGB2 may be e.g. greater than or equal to 20% of the total length L_{B} of the grating G1. If the grating comprises the third region REGB3, the length of the region REGB3 may be e.g. greater than or equal to 20% of the total length L_{B} of the grating G1.

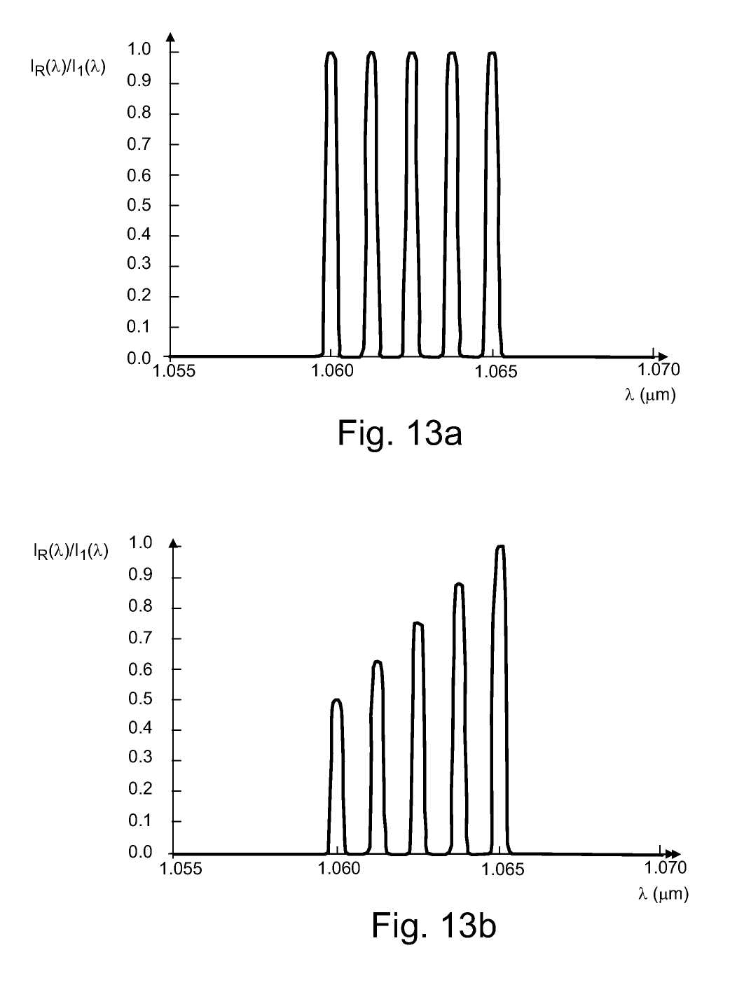

In the previous discussion, a non-periodic period length function Λ_{B}(z) covers the whole length of a grating G1. However, the period length function Λ_{B}(z) may also have a substantially longer period P such that Λ_{B}(z)=Λ_{B}(z+P). The period P is by several orders of magnitude longer than the grating period Λ_{B} (i.e. P>>Λ_{B}(z)). The longer period P may be e.g. in the range of 1 mm to 3 mm, whereas the grating period Λ_{B}(z) is typically shorter than 1 μm. This may correspond to a situation where a plurality of similar grating zones having a length P are positioned one after another so as to form a single combined grating G1. Referring to FIGS. 13a and 13b, grating structures having the longer periodicity may provide a spectral reflectance curve having two or more substantially discrete reflectance bands. A plurality of consecutive grating zones may provide several discrete reflectance peaks whose mutual intensity may be tuned. FIGS. 13a and 13b show reflectance curves having several peaks. The intensity of each peak may be chosen independently. An optical filter having a reflectance curve of FIG. 13a or 13b may be utilized e.g. for processing optical data signals.

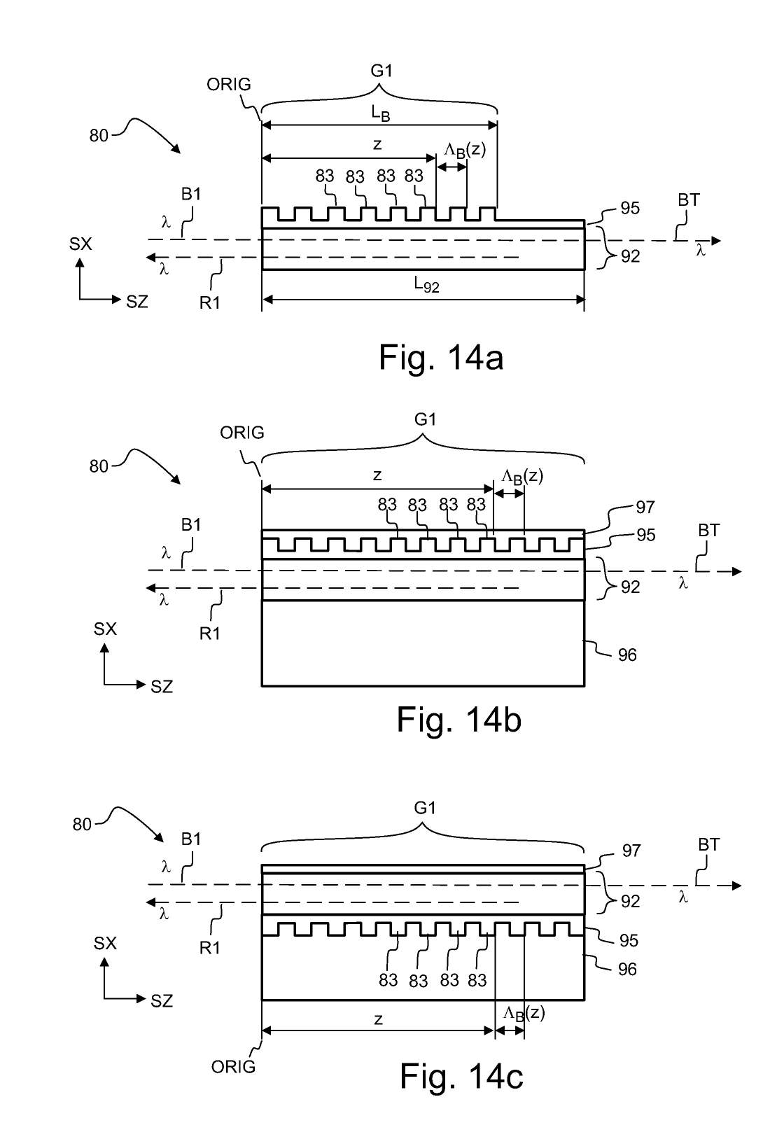

FIGS. 14a-14c show various ways to implement an optical component 80, which has a waveguide 92 perturbed by a grating G1.

Referring to FIG. 14a, the length L_{B} of the grating G1 in the direction SZ may be shorter than the length L₉₂ of the waveguide 92.

Referring back to FIG. 1, the length L_{B} of the grating G1 may be substantially equal to the length L₉₂ of the waveguide 92.

Referring to FIG. 14b, the grating G1 and/or the waveguide 92 may be protected with a protective layer 97, 96 e.g. against contamination and/or scratching. In particular, the waveguide 92 may be implemented on a substrate 96, which also protects the waveguide 92.

The waveguide 92 may be e.g. a core of an optical fiber or a planar waveguide.

The refractive index of the substrate 96 may be lower than the refractive index of the waveguide 92 in order to enable total internal reflection (TIR) for beams propagating in the waveguide 92.

The refractive index of the grating layer 95 may be lower than the refractive index of the waveguide 92 so that the grating layer 95 may also operate as a cladding layer (to enable total internal reflection).

Also the refractive index of the protective layer 97 may be lower than the refractive index of the waveguide 92.

The refractive index of the protective layer 97 may be different from the refractive index of the diffractive features 83 of the grating G1. The refractive index of the protective layer 97 may be different from the refractive index of the grating layer 95.

The waveguide 92 may also be a graded index waveguide, i.e. the refractive index may vary smoothly in the direction SX.

Referring to FIG. 14c, the grating G1 may also be implemented between the waveguide 92 and the substrate 96.

The diffractive features 83 may be e.g. diffractive ridges implemented on the layer 95 or on the waveguide 92 by lithographic etching. The diffractive features 83 may be e.g. diffractive defects implemented in the waveguide 92 e.g. by laser scribing.

The diffractive features 83 may be implemented on the waveguide 92, inside a waveguide 92, or under a waveguide 92 (FIG. 14c). The diffractive features 83 may be protected by a covering layer (FIGS. 14b and 14c).

The diffractive features 83 of the grating G1 may be implemented directly on a surface of the waveguide 92, i.e. the layer 95 may be omitted.

Diffractive elements 83 may be implemented on two or more sides of a waveguide 92, e.g. on an upper side and on a lower side.

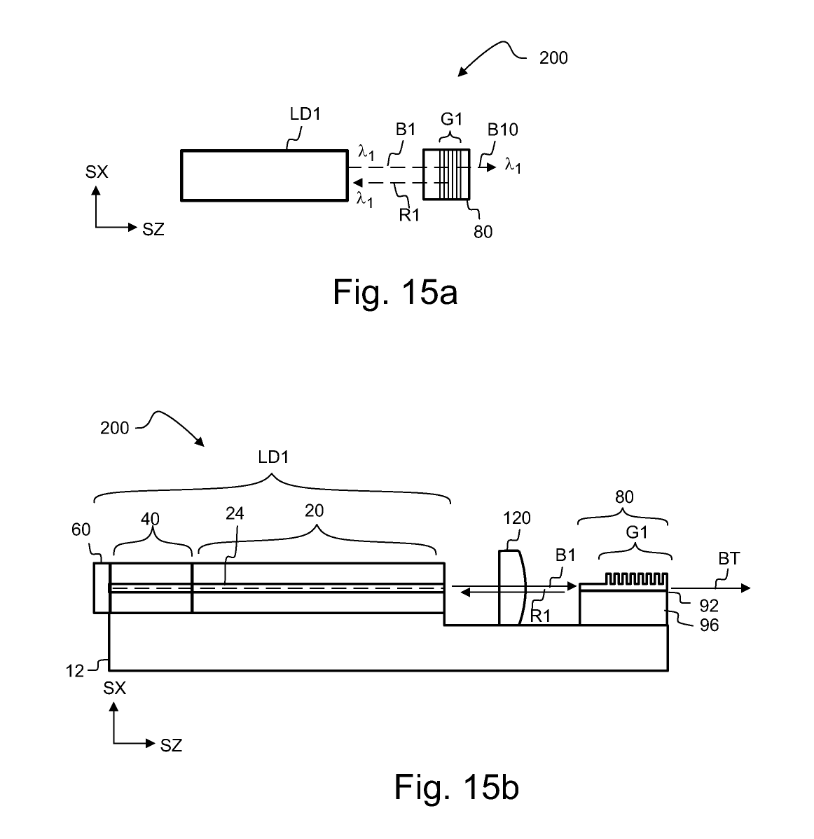

Referring to FIG. 15a, a light source 200 may comprise a (laser) light-emitting unit LD1 and a spectrally selective component 80 (i.e. a filter). The spectrally selective component 80 comprises a grating G1. The grating G1 may be arranged such that the reflectance band of the component 80 has a substantially wide and substantially flat top (see e.g. FIG. 5). The spectrally selective component 80 may be arranged to provide optical feedback R1 to the light-emitting unit LD1 by wavelength-selectively reflecting light B1 emitted from the unit LD1.

The feedback may facilitate for example:
stabilizing the central wavelength λ₁ of an output beam B10 provided by the light source 200,
stabilizing the optical power of the output beam B10,
maximizing the optical power of the output beam B10, and/or
improving the tolerance to temperature variations of the light-emitting unit LD1.

The light source 200 may be a laser light source. A problem with coherent laser light illumination is that the coherent light may create annoying speckle patterns. Providing wideband optical feedback with the grating G1 to the light-emitting unit LD1 may reduce the speckle.

Referring to FIG. 15b, the light source 200 may comprise a light-emitting unit LD1, which is arranged to provide pulsed light B1. The light-emitting unit LD1 may comprise a waveguide 24 having a gain region 20. The light-emitting unit LD1 may further comprise a semiconductor saturable absorber 40, a first reflecting structure 60, and a substrate 12. The combination of the saturable absorber 40 and the first reflecting structure 60 is also known by the acronym SESAM (semiconductor saturable absorber mirror). The gain region 20 and the saturable absorber 40 may be implemented on the common substrate 12. The light-emitting unit LD1 may also be called as an emitter.

The light source 200 may optionally comprise a light coupling element 120, e.g. a lens for coupling light B1 emitted from the light-emitting unit LD1 to the grating G1 and/or to couple reflected light R1 to the light-emitting unit LD1. Alternatively, the end of the waveguide 92 may be positioned close to the end of the waveguide 24 in order to enable effective optical coupling.

Referring to FIG. 16a, second light B2 may be generated from first light B1 by sum frequency generation (SFG) in optically nonlinear material. In particular, the second light may be generated by second harmonic generation (SHG). A crystal NLC may comprise optically nonlinear material. The crystal NLC may be called as a nonlinear crystal. The nonlinear crystal NLC may also be called as a wavelength conversion device NLC or a wavelength conversion unit NLC.

A light source 200 may comprise a light emitting unit LD1 and a nonlinear crystal NLC. (Infrared) light B1 provided by the light emitting unit LD1 may be coupled into the nonlinear crystal NLC. (Visible) light B2 may be generated in the nonlinear crystal NLC by frequency conversion. The light B1 has a wavelength λ₁. The light B2 has a wavelength λ₂. The optical frequency corresponding to the wavelength λ₂ may be substantially equal to two times an optical frequency corresponding to the wavelength λ₁.

The first light B1 may be e.g. infrared light (wavelength in vacuum longer than 760 nm), and the second light B2 may be visible light (wavelength in vacuum in the range of 400 nm to 760 nm). Alternatively, the first light B1 may be visible light (wavelength in vacuum in the range of 400 nm to 760 nm), and the second light may be ultraviolet light (wavelength in vacuum shorter than 400 nm).

For example, more than 50% of optical energy of the first light B1 may be converted into optical energy of the second light B2 by sum frequency generation (SFG) when the Δλ_{FWHM} of the first light B1 is greater than or equal to 0.5 nm.

The conversion efficiency of a nonlinear crystal NLC depends on the momentary intensity prevailing in the crystal. The first light B1 and the second light B2 may be pulsed in order to increase conversion efficiency and/or in order to reduce speckle patterns. Pulsing of the light B1 may increase the peak intensity of the first light B1 in the crystal NLC, thereby increasing the conversion efficiency Eff. Pulsing of the light B1 may also reduce coherence of the light beam B2, thereby reducing visually annoying speckle patterns.

The crystal NLC may comprise e.g. optical waveguides, grating structures, antireflection coatings and/or protective coatings. The nonlinear crystal NLC may be (periodically) poled in order to provide quasi-phase-matching conditions. Quasi-phase-matching may increase conversion efficiency.

The optical beams B1 and B2 may propagate substantially in the direction SZ through the nonlinear crystal NLC.

Referring to FIGS. 16b, 16c and 16d, the light source 200 may comprise a light-emitting unit LD1, a nonlinear crystal NLC, and a spectrally selective component 80. The spectrally selective component 80 may comprise a waveguide 92 and a grating G1. The spectrally selective component may be arranged to provide wavelength-selective optical feedback R1 to the light emitting unit LD1. In particular, the spectrally selective component 80 may be arranged to provide wavelength-selective optical feedback R1 to the light-emitting unit LD1 through the nonlinear crystal NLC.

The speckle contrast may be minimized by reducing the duration of light pulses provided the light source 200. The use of short light pulses also provides a high efficiency of converting electrical energy into energy of visible light. In particular, very short light pulses may be provided when emitted high-intensity pulses travel through the gain region 20 only once. This may be achieved e.g. by cavity dumping. The grating G1 may be adapted to provide wavelength-selective optical feedback at a predetermined wavelength range matching with the wavelength of the light pulses B1. The grating G1 may allow stabilization of the wavelength of the beam B1 and generation of light pulses by cavity dumping. Optical feedback provided by the combination of the nonlinear crystal NLC and the grating G1 is substantially smaller for high-intensity light pulses than for the low-intensity light. Thanks to the intensity-dependent feedback, the fall time of the generated pulses may be very short. Consequently, very short and intense light pulses of visible light may be generated at a high efficiency.

Referring to FIG. 16d, the light source 200 may comprise a beam directing structure M45, which is arranged to change the direction of the first light B1 emitted from the gain region 20. The direction of the first light B1 may be changed by an angle β1, which is e.g. in the range of 80 to 110 degrees. The folded arrangement of FIG. 16d may provide a more compact structure, a more stable structure and easier alignment of the optical components than the linear arrangement of FIG. 16c. In particular, the light concentrating structure 120 may be implemented on the substrate 10 of the light emitting unit LD1. The common substrate 10 may be of a substantially transparent (semiconductor) material.

The light concentrating structure 120 shown in FIGS. 15b, 16c, 16d may be e.g. a refractive or diffractive lens.

The use of the light concentrating structure 120 may be omitted e.g. when the distance between the light-emitting unit LD1 and the crystal NLC is small enough.

Manufacturing, structure, and operation of suitable light emitting units LD1 has been described e.g. in a patent publication WO 2008/087253, herein incorporated by reference.

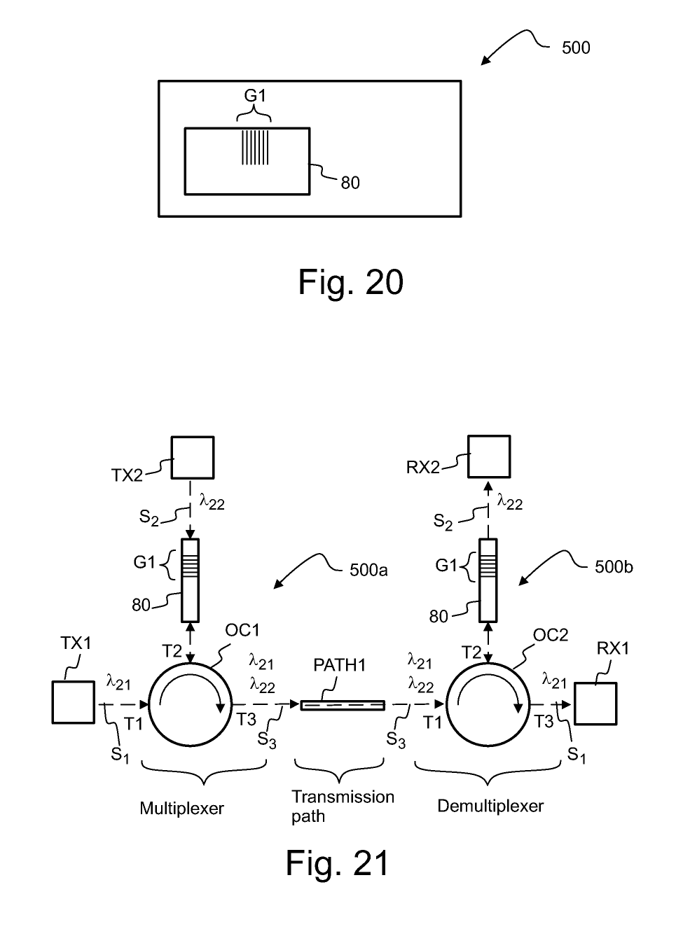

The light source 200 comprising a nonlinear crystal NLC may be a part of an image projector 500 for projecting images on an external screen (FIG. 20 shows a generic optical device 500). Light B2 provided by the light source 200 may be modulated and/or directed such that a visible image may be formed on the external screen. The light source 200 may be a part of a display unit 500 for displaying images. The display unit may be e.g. a television or a virtual display. Light B2 provided by the light source 200 may be modulated and/or directed such that a visible image may be displayed. The light source 200 comprising a nonlinear crystal NLC may be a part of a light torch 500 used for illumination. The light torch 500 may be a handheld portable torch or a lamp of a vehicle, ship or airplane.

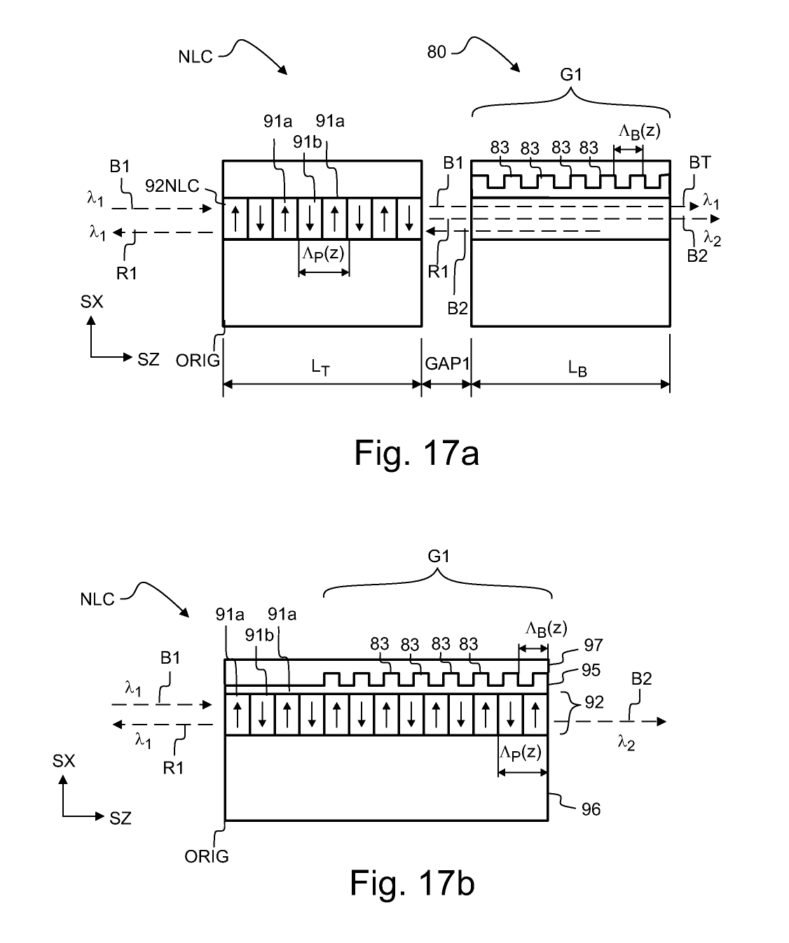

Referring to FIG. 17a, the nonlinear crystal NLC may be (periodically) poled in order to provide quasi-phase-matching conditions. Quasi-phase-matching may increase conversion efficiency. Λ_{P}(z) denotes the length of a poling period as a function of a position. The poling period length Λ_{P}(z) may be determined in the direction of propagation of the light B1 (i.e. in the direction SZ). L_{T} denotes the (total) length of the crystal NLC.

The crystal NLC may comprise a waveguide 92NLC for guiding light by total internal reflection (TIR). Light B1 may be coupled from the crystal NLC to a spectrally selective optical component 80 and/or light R1 may be coupled from the component 80 to the crystal NLC. The width of a gap GAP1 between the crystal NLC and the component 80 may be selected so as to enable effective coupling. The component 80 may also be in contact with the crystal NLC. Light may be coupled from the crystal 80 to the component 80 also by a lens.

Referring to FIG. 17b, the nonlinear crystal NLC may comprise a grating G1 arranged to provide wavelength-selective feedback to a light emitting unit LD1. The crystal NLC may further comprise (periodically) poled zones 91a, 91b.

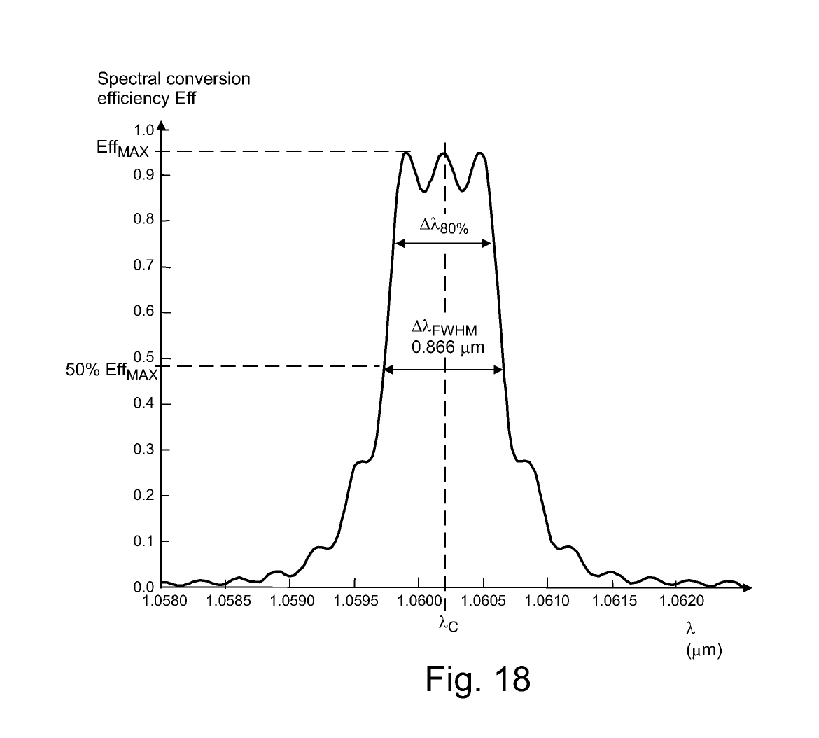

FIG. 18 shows spectral conversion efficiency of a nonlinear crystal NLC. λ_{C} denotes a central wavelength of the conversion efficiency band. Eff_{MAX} denotes maximum conversion efficiency.

The lengths Λ_{P} of poling periods of a nonlinear crystal NLC may depend on the location z. The lengths Λ_{P} of the poling periods may be specified by a poling period function Λ_{P}(z). To a certain extent, the position λ_{C} and the width Δλ_{FWHM} of the conversion efficiency curve may be modified by using a suitable poling period function Λ_{P}(z).

The position λ₀ and the width Δλ_{FWHM} of the spectral reflectance band of the spectrally selective component 80 may be selected to substantially match with the position λ_{C} and the width Δλ_{FWHM} of the conversion efficiency curve of the nonlinear crystal NLC.

The poling period function Λ_{P}(z) and/or the grating period function Λ_{B}(z) may be selected such that the position λ₀ and the width Δλ_{FWHM} of the spectral reflectance band of the spectrally selective component 80 substantially matches with the position λ_{C} and the width Δλ_{FWHM} of the conversion efficiency curve of the nonlinear crystal NLC.

A poling period function Λ_{P}(z) providing a desired conversion efficiency function may also be determined by using an iterative Fourier transform algorithm, as discussed in the U.S. provisional application 61/418,478.

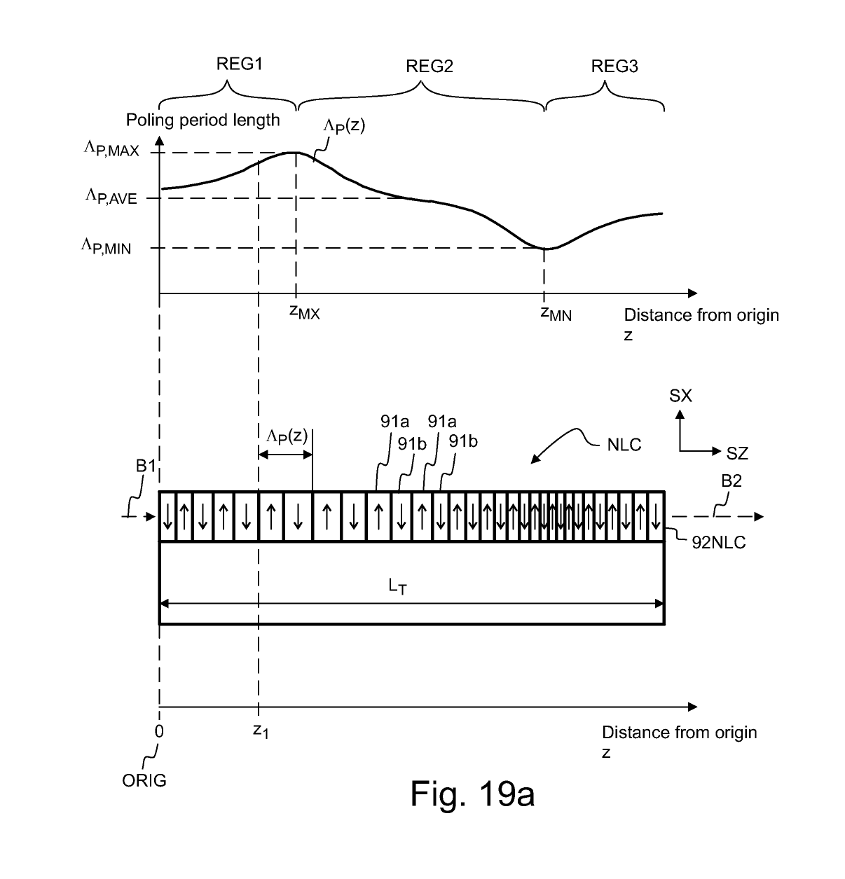

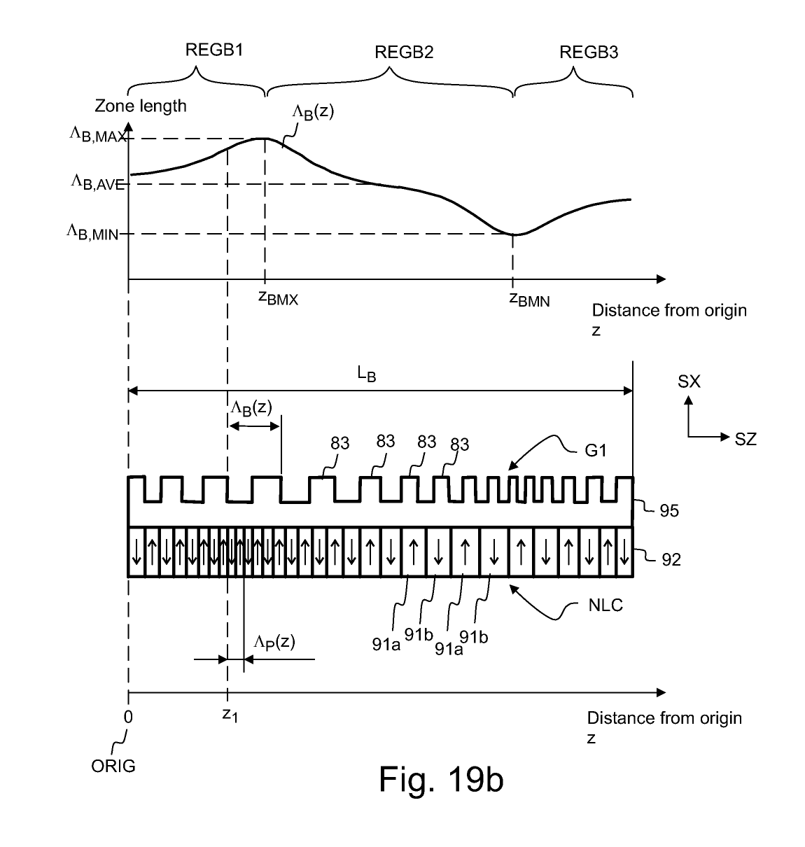

Referring to FIG. 19a, the nonlinear crystal NLC may have a first region REG1 and a second region REG2 such that the lengths of the poling periods increase with increasing distance z from the origin ORIG in the first region REG1, and the lengths of the poling periods decrease with increasing distance z in the second region REG2. The nonlinear crystal NLC may further have a third region REG3 such that the second region REG2 is located between the first region REG1 and the third region REG3.

Λ_{P,MAX} denotes the maximum length of the poling period Λ_{P}. Λ_{P,MIN} denotes the minimum length of the poling period Λ_{P}. Λ_{P,AVE} denotes the average length of the poling period Λ_{P}. z_{MX} denotes a distance z where the poling period Λ_{P} attains the maximum value Λ_{P,MAX}. z_{MN} denotes a distance z where the poling period Λ_{P} attains the minimum value Λ_{P,MIN}.

The position z_{MX} may mark the boundary between the first region REG1 and the second region REG2. The position z_{MN} may mark the boundary between the second region REG2 and the third region REG3.

The length of the first region REG1 may be e.g. greater than or equal to 5% of the total length L_{T} of the poled portion of the crystal NLC. The length of the second region REG2 may be e.g. greater than or equal to 5% of the total length L_{T}. If the crystal NLC comprises the third region REG3, the length of the region REG3 may be e.g. greater than or equal to 5% of the total length L_{T}.

Various configurations of the nonlinear crystal and methods for determining the poling period function Λ_{P}(z) are disclosed in a U.S. provisional patent application 61/418,478. In particular, a poling period function Λ_{P}(z) providing a desired conversion efficiency function may be determined by using the Iterative Fourier Transformation Algorithm (IFTA).

Referring to FIG. 19b, a (periodically) poled nonlinear crystal NLC may comprise a grating G1 such that the grating period function Λ_{B}(z) provides a desired spectral reflectance function I_{R}(λ)/I₁(λ).

Referring to FIG. 20, a device 500 may comprise one or more spectrally selective components 80, wherein the components 80 may comprise one or more gratings G1.

In particular, the device 500 and/or the spectrally selective component 80 may be an optical filter, which comprises a grating G1 arranged to reflect and/or transmit light propagating in the waveguide 92. The optical filter may be a grating G1 arranged to reflect and/or transmit light propagating in the waveguide 92.

The device 500 and/or the spectrally selective component 80 may be an optical fiber, wherein a grating G1 implemented in or on the fiber may be arranged to couple a light beam from a core of the fiber to cladding of the fiber. A grating G1 implemented in or on an optical fiber may be arranged to couple a light beam from the cladding of the fiber to the core of the fiber.

The device 500 may be an apparatus comprising integrated optics. The device 500 may comprise a grating G1 arranged to operate as an optical coupler. Thanks to the grating G1, the shape of the output/input beam can be tuned and the bandwidth can be tailored.

The device 500 may be e.g. a fiber laser, where a grating G1 is arranged to provide optical feedback and/or to filter optical output of the fiber laser (FIG. 15a). The spectral reflectance of the grating G1 may be tailored to suppress or maintain one or more (desired) wavelength bands of an optical output beam of the fiber laser 500.

The device 500 may be a laser light source 200 arranged to provide pulsed light. The laser light source 200 may comprise a grating G1 arranged to provide optical feedback so as to stabilize output wavelength of the laser light source (FIGS. 15a, 15b, 16b, 16c, 16d). Thanks to the wide spectral reflectance band, the level of (unwanted) speckle may be reduced e.g. by more than 60%.

The device 500 may be a laser light source 200, which comprises a nonlinear crystal arranged to generate light by second harmonic generation (SHG) and/or by sum frequency generation (SFG) (FIGS. 16a-16d). The device 500 may further comprise a grating G1 arranged to provide optical feedback so as to stabilize output wavelength of the laser light source. Thus, greater variations in the operating temperature of the nonlinear crystal may be tolerated. For example, the variation of operating temperature should be kept smaller than ±1° C. when the light source does not comprise the grating. With the grating, the variation of the operating temperature may be e.g. up to ±5° C. Thanks to the wavelength stabilization, High and stable conversion efficiency may be provided.

The device 500 may be a Wavelength-Division-Multiplexer-Coupler (WDM), which is suitable for transmitting and/or processing an optical data signal. The WDM-coupler 500 may comprise a grating G1. The grating G1 may have one or more reflectance peaks at the desired location(s). The height of individual reflectance peaks may be selected according to the application.

FIG. 21 shows an optical communications system comprising a first Wavelength-Division-Multiplexer-Coupler 500a in a transmitting end and a second Wavelength-Division-Multiplexer-Coupler 500b in a receiving end. The first coupler 500a may comprise a first spectrally selective component 80 and an optical circulator OC1. Also the second coupler 500b may comprise a second spectrally selective component 80 and a second optical circulator OC2. The first coupler 500a may be arranged to operate as a multiplexer and the second coupler 500b may be arranged to operate as a demultiplexer.

The transmitting end may comprise a first transmitter TX1 and a second transmitter TX2. The first transmitter TX1 may provide a first optical (data) signal S₁ at a first wavelength λ₂₁, and the second transmitter TX2 may provide a second optical (data) signal S₂ at a second (different) wavelength λ₂₂.

The first data signal S₁ may be coupled to a first port T1 of a first optical circulator OC1. The circulator OC1 couples the signal S₁ out of the port T2.

The second data signal S₂ may be coupled via an optical filter 80 to a second port T2 of the first optical circulator OC1. The filter 80 may have a high transmittance for the signal S₂ at the wavelength λ₂₂, and the filter 80 may have a high reflectance for the signal S₁ at the wavelength λ₂₁. Consequently, both signals S₁ and S₂ are coupled into the port T2 of the optical circulator OC1. The circulator OC1 may form a spectrally multiplexed signal S₃ by coupling both signals S₁, S₂ out of the port T3.

The multiplexed signal S₃ may be transmitted via an optical communication path PATH1 to the receiving end. The communication path PATH1 may be e.g. an optical fiber. The length of the communication path PATH1 may be e.g. longer than 1 km.

In the receiving end of the communication system, the signal S₃ may be coupled into a first port T1 of the second optical circulator OC2. The circulator OC1 couples the signal S₃ out of the port T2 to the second optical filter 80. The filter 80 may have a high transmittance for the signal S₂ at the wavelength λ₂₂, and the filter 80 may have a high reflectance for the signal S₁ at the wavelength λ₂₁. Consequently, the signal S₂ may be transmitted through the filter 80 to a second optical receiver RX2. The signal S₁ may be reflected by the filter 80 so that it is coupled back to the port T2 of the second optical circulator OC2. The second optical circulator OC2 may subsequently couple the signal S₁ out of the port T3 of the circulator OC to a first optical receiver RX1. Thus, the second coupler 500b may spectrally separate the signal S₁ from the multiplexed signal S₃. Thus, the second coupler 500b may spectrally separate the first signal S₁ from the second signal S₂.

When the gratings G1 have wide and flat reflectance band, the multiplexing and/or demultiplexing may be carried out reliably even in a situation where the wavelengths λ₂₁, λ₂₂ of the signal S₁, S₂ have small fluctuations.

Signals at three or more different wavelengths may be spectrally multiplexed by using two or more multiplexing couplers 500a. For example an output port T3 of a first multiplexing coupler 500a may be coupled via an optical filter 80 to a port T2 of a second multiplexing coupler 500a in order to combine signals coupled to ports T1, T2 of the first multiplexing coupler 500a with a signal coupled to a port T1 of the second multiplexing coupler 500a.

Signals at three or more different wavelengths may be spectrally de-multiplexed by using two or more de-multiplexing couplers 500b.

The origin ORIG may be located e.g. at an edge of the grating G1 (see e.g. FIG. 1). In particular, the origin ORIG may coincide with the diffractive feature 83 which first interacts with the input beam B1.

The expression “reflected” means herein that diffraction of a first beam B1 propagating in the waveguide 92 provides a second beam R1, which propagates in a direction which substantially deviates from the direction of propagation of the first beam B1. In particular, the direction of propagation (−SZ) of the beam R1 may be opposite the direction of propagation (+SZ) of the input beam B1. The beams B1 and BT may propagate substantially in the direction SZ. The beam R1 may propagate substantially in the direction −SZ (i.e. in a direction, which is opposite the direction SZ).

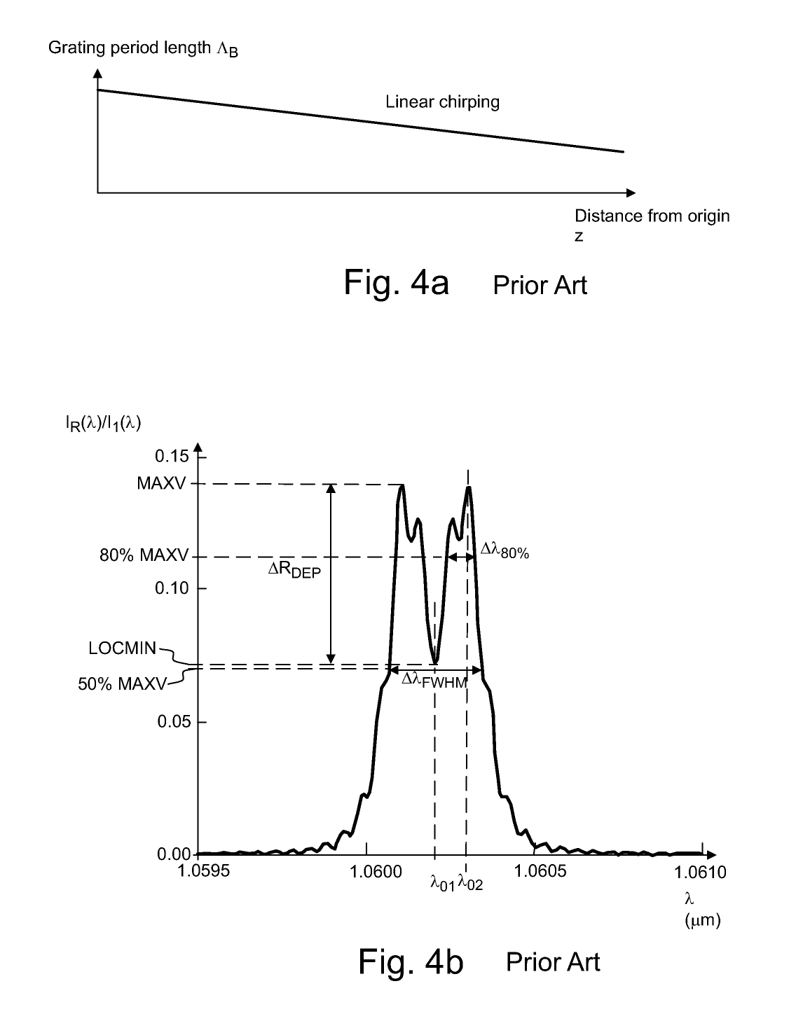

Referring back to FIG. 4b, the central wavelength λ₀ of a spectral reflectance function may be considered to be at the center of gravity (e.g. wavelength λ₀₁) or at a wavelength associated with the maximum value (e.g. wavelength λ₀₂), depending on the application.

The expression “nonlinear” does not define the geometrical form of a “nonlinear” crystal NLC. In particular, the nonlinear crystal may be a rectangular parallelepiped.

The dimensions of the diffractive features 83 and the microzones shown in the figures are exaggerated. In practice, the dimensions of the diffractive features 83 may be microscopic.

For the person skilled in the art, it will be clear that modifications and variations of the devices and methods according to the present invention are perceivable. The figures are schematic. The particular embodiments described above with reference to the accompanying drawings are illustrative only and not meant to limit the scope of the invention, which is defined by the appended claims.

1-23. (canceled)

24. A device, comprising:
a combination of a waveguide and a grating arranged to provide a spectral reflectance, wherein the grating has a plurality of diffractive features in a first region and in a second region such that:
in the first region, a local average of a length of a period of the diffractive features substantially increases with increasing distance from an origin, and
in the second region, the local average of the length of the period of the diffractive features substantially decreases with increasing distance from an origin, and
wherein the origin is located at an end of the device.

25. The device according to claim 24, further comprising:
a third grating region such that:
the second region is between the first region and the third region, and
in the third region, the local average of the length of the period of the diffractive features substantially increases with increasing distance from the origin.

26. The device according to claim 24, wherein a length of the first region is greater than or equal to 5% of a total length of the grating, and wherein a length of the second region is greater than or equal to 5% of the total length of the grating.

27. The device according to claim 24, wherein the width Δλ80% of the spectral reflectance is greater than 0.5 nm.

28. The device according to claim 24, wherein a ratio of a width Δλ80% of the spectral reflectance to a width ΔλFWHM of the spectral reflectance is greater than or equal to 0.6, wherein the width Δλ80% denotes a spectral width at a height that is 80% of a maximum value of the spectral reflectance, and the width ΔλFWHM denotes the spectral width at a height that is 80% of the maximum value of the spectral reflectance.

29. The device according to claim 24, wherein a grating period function of the grating substantially corresponds to a phase of a coupling coefficient function, and wherein the coupling coefficient function is obtained by calculating a Fourier transform of a square root of the spectral reflectance.

30. The device according to claim 24, wherein a grating period function of the grating substantially corresponds to a phase of a coupling coefficient function, and wherein the coupling coefficient function has been determined such that a spectral reflectance function is substantially proportional to a function, which is equal to a square of an absolute value of an inverse Fourier transform of the coupling coefficient function.

31. The device according to claim 24, wherein a locally averaged grating period function of the grating substantially corresponds to a phase of a coupling coefficient function, and wherein the coupling coefficient function is obtained by calculating a Fourier transform of a square root of the spectral reflectance.

32. The device according to claim 24, wherein a locally averaged grating period function of the grating substantially corresponds to a phase of a coupling coefficient function, and wherein the coupling coefficient function has been determined such that a spectral reflectance function is substantially proportional to a function, which is equal to a square of an absolute value of an inverse Fourier transform of the coupling coefficient function.

33. The device according to claim 31, wherein lengths of the periods of the diffractive features of the grating are quantized.

34. The device according to claim 24, wherein the device is a light source comprising a light-emitting unit.

35. The device according to claim 34, wherein the grating is arranged to provide optical feedback to the light-emitting unit.

36. The device according to claim 34, further comprising:
a nonlinear crystal arranged to provide light by at least one of a second harmonic generation or a sum frequency generation.

37. The device according to claim 36, wherein the grating is arranged to provide optical feedback to the light-emitting unit through the nonlinear crystal.

38. The device according to claim 24, wherein the device is at least one of an optical multiplexer or an optical demultiplexer.

39. A method, comprising:
filtering light by using a combination of a waveguide and a grating,
wherein the grating has a plurality of diffractive features in a first region and in a second region such that:
in the first region a local average of a length of a period of the diffractive features substantially increases with increasing distance from an origin, and
in the second region, the local average of the length of the period of the diffractive features substantially decreases with increasing distance from an origin, and
wherein the origin is located at an end of the grating.

40. The method according to claim 39, further comprising:
providing optical feedback to a light-emitting unit.

41. The method according to claim 39, further comprising:
at least one of spectrally multiplexing or demultiplexing optical signals.

42. A method, comprising:
producing a combination of a grating and a waveguide, the combination being arranged to provide a spectral reflectance, wherein the grating has a plurality of diffractive features such that:
in a first region, a local average of a length of a period of the diffractive features substantially increases with increasing distance from an origin, and
in the second region, the local average of the length of the period of the diffractive features substantially decreases with increasing distance from an origin, and
wherein the origin is located at an end of the grating.

43. The method according to claim 42, wherein a ratio of a width Δλ80% of the spectral reflectance to a width ΔλFWHM of the spectral reflectance is greater than or equal to 0.6, wherein the width Δλ80% denotes the spectral width at a height, which is 80% of a maximum value of the spectral reflectance, and the width ΔλFWHM denotes the spectral width at a height, which is 80% of the maximum value of the spectral reflectance.

44. The method according to claim 42, wherein a grating period function of the grating substantially corresponds to a phase of a coupling coefficient function obtained by calculating a Fourier transform of a square root of the spectral reflectance of the combination of the grating and the waveguide.

45. The method according to claim 42, wherein a locally averaged grating period function of the grating substantially corresponds to a phase of a coupling coefficient function obtained by calculating a Fourier transform of a square root of the spectral reflectance.

46. The method according to claim 44, further comprising:
determining the coupling coefficient function by an iterative Fourier transform algorithm.
